(19) United States
(12) Patent Application Publication
(10) Pub. No.: US 2012/0129590 A1
(43) Pub. Date: May 24, 2012

(54) System and Method for Interactive Location-Based Gameplay

(76) Inventors: Brian Morrisroe, San Francisco, CA (US); David Wang, Palo Alto, CA (US); Keith Lee, San Francisco, CA (US)

(21) Appl. No.: 13/165,700

(22) Filed: Jun. 21, 2011

Related U.S. Application Data
(60) Provisional application No. 61/398,157, filed on Jun. 21, 2010.

(51) Int. Cl. A63F 13/00

(52) U.S. Cl. 463/25

(57) ABSTRACT

Disclosed is a system comprising a location engine for detecting the location of the system, an attraction engine for identifying an attraction proximate to the system, a gameplay engine for enabling gameplay of a user to earn virtual credits based on the proximity, and a virtual item engine for providing a virtual item to the user during gameplay, the virtual item having a real-world implication and being usable by the gameplay engine for an increase or decrease of virtual credits.

### REFERENCE TO EARLIER-FILED APPLICATION

This Application seeks priority to and benefit of U.S. Provisional Patent Application Ser. No. 61/398,157, filed Jun. 21, 2010, entitled “SYSTEM AND METHOD FOR CREATING A VIRTUAL CITY AND SOCIAL NETWORK,” which is incorporated by reference herein.

### TECHNICAL FIELD

This invention(s) relate generally to gaming on a mobile device and more particularly provides systems and methods for interactive location-based gameplay on mobile devices.

### BACKGROUND

Gaming has become ubiquitous in the new electronic age. As the number of and power of mobile devices as dramatically increased, there has been a steady drive for new forms of entertainment. In response, large and small applications have been developed for mobile platforms. Many games are “apps” which can be downloaded for free or for a small fee.

Game developers, however, have struggled with interacting reality with gameplay in a financially successful manner. Although people enjoy services that provide location-based information, people resist paying for services or receiving direct advertisements. For instance, many users readily turn to their mobile devices for information about the real-world, such as addresses, telephone numbers, and event schedules. Many users also readily rely on their mobile devices for location-based mapping services that provide information such as directions to places or events. Games, however, have remained as entertainment only.

### SUMMARY

In some embodiments, a system comprises a location engine for detecting the location of the system, an attraction engine for identifying an attraction proximate to the system, a gameplay engine for enabling gameplay of a user to earn virtual credits based on the proximity, and a virtual item engine for providing a virtual item to the user during gameplay, the virtual item having a real-world implication and being usable by the gameplay engine for an increase or decrease of virtual credits. The virtual item may identify a real-world item. The real-world implication may be a good, service, person, establishment, or entertainment experience. In exemplary embodiments, the real-world item includes audio, video, or text content. The real-world implication may include a video game. The attraction may include a business, residence or other location. The attraction may include an event, which may exist only during a specified time period.

The virtual item may include branding information, advertisement information, or a coupon. The virtual item may include audio, video, or text content.

The virtual item engine may select the virtual item from a data structure of virtual items. The virtual item may be selected based on user location. The virtual item may be selected based on likely proximity of the user to a real-world item. The virtual item may be selected based the attraction. The virtual item may be selected based on environmental factors. The virtual item may be selected based on economic factors. The virtual item may be selected based on information about the user. In exemplary embodiments, selection of the virtual item is based on the time of day or at random. In some embodiments, the virtual item is selected based on information about other persons associated with the user. The real-world implication of the virtual item may be limited by one or more conditions. For example, the virtual item may have real-world implication if combined with other virtual items or may have real-world implication if transmitted to other users.

The virtual credits may include virtual cash, points, levels, tools, or achievements, which form a part of gameplay. In exemplary embodiments, gameplay includes enabling a user to check-in at the attraction in exchange for virtual credits. Gameplay may also include enabling the user to purchase the attraction using virtual credits. The gameplay engine may enable a user to earn virtual credits based on the proximity by enabling a user to interact with the attraction only when the user is within a predetermined distance of the attraction. In some embodiments, the virtual item is usable by the gameplay engine for an increase or decrease of virtual credits by affecting the value of another virtual item. The virtual item may also be usable by the gameplay engine for an increase or decrease of virtual credits by affecting a proximity threshold or a proximity award. The virtual item may be usable by the gameplay engine for an increase or decrease of virtual credits by receiving a tool capable of improving the user's chance of increasing or decreasing virtual credits.

In some embodiments, the present application discloses a method comprising enabling gameplay of a user to earn virtual credits based on proximity of a mobile device to a user-selected attraction, selecting an interactive virtual item having a real-world implication, the selection based at least in part on an attribute of the user-selected attraction, sending the interactive virtual item to the mobile device, receiving interaction information relating to the interactive virtual item, and modifying the virtual credits based on the interaction information. Selecting the interactive item may comprise evaluating web analytic data corresponding to the user. The method may further comprise modifying the virtual item based on the interaction information.

In exemplary embodiments, the present application discloses a computer readable medium having embodied thereon executable instructions, the executable instructions being executable by a processor for performing a method, the method comprising enabling gameplay of a user to earn virtual credits based on proximity of a mobile device to a user-selected attraction, selecting an interactive virtual item having a real-world implication, the selection based at least in part on an attribute of the user-selected attraction, sending the interactive virtual item to the mobile device, receiving interaction information relating to the interactive virtual item, and modifying the virtual credits based on the interaction information.

### BRIEF DESCRIPTION OF THE DRAWINGS

FIG. 1 is a block diagram of a gameplay system, according to some embodiments.

FIG. 2 is a box diagram of a digital device in some embodiments.

FIG. 3 is a block diagram of the game server system in some embodiments.

FIG. 4 is a block diagram of the gameplay server engine in some embodiments.

FIG. 5 is a block diagram of a gameplay client controller in some embodiments.

FIG. 6 is a block diagram of a virtual item in some embodiments.

FIG. 7 shows a gameplay method in some embodiments.

FIG. 8 is a method of the virtual item selection method in some embodiments.

FIG. 9 shows an initial screen in some embodiments.

FIG. 10 shows an exemplary virtual item inventory in some embodiments.

FIG. 11 shows a scratch game screen in some embodiments.

FIG. 12 is another virtual inventor in some embodiments.

FIG. 13 shows a stack of cash screen in some embodiments.

FIG. 14 shows an orange juice screen in some embodiments.

FIG. 15 shows a money sack screen in some embodiments.

FIG. 16 shows another virtual item inventory in some embodiments.

FIG. 17 depicts the local attraction screen in some embodiments.

FIG. 18 is a local attraction check-in screen in some embodiments.

FIG. 19 is the completed check-in screen in some embodiments.

FIG. 20 is a stamp screen in some embodiments.

FIG. 21 depicts a parts screen in some embodiments.

FIG. 22 is an advertisement screen in some embodiments.

FIG. 23 depicts a video regarding savings associated with HP in some embodiments.

### DETAILED DESCRIPTION OF THE INVENTION

The following description is provided to enable any person skilled in the art to make and use the invention and is provided in the context of a particular application. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

In various embodiments, a gaming environment on a mobile device may allow users to interact with both a virtual and real world environment. In one example, a gaming environment may comprise both real-world attractions and associated virtual attractions. An attraction is a store, business, headquarters, school, church, theme park, concert, sporting event, party, town hall, meeting, or the like. As a user may visit a restaurant in the real-world, they may check-in to a virtual version of the restaurant as well. Checking in to a restaurant during gameplay may benefit the user (e.g., increase in virtual credits of points or virtual currency) during gameplay.

Within the virtual environment of gameplay, the user may receive a virtual item with associated real-world content (i.e., a real world implication). Associated real-world content may be any information provided by the virtual item that is related to a real-world good or service. For example, a user may engage in a virtual computer and receive real-world content (e.g., a video of an HP computer, advertisement of computer services, a coupon for maintenance work, or a discount for network administration training courses).

By providing real-world content to virtual items received in gameplay, a player may be further engaged in both the game and within their surrounding environment. Players may receive benefits within gameplay for taking advantage of real world-content, such as additional points for downloading a ringtone. Further, players may receive benefits within the real world while playing the game (e.g., coupons, discounts, or ticket availability). The virtual items themselves may also represent both real and virtual items. For example, a virtual item may include an appearance of a branded soft drink thereby providing advertisement opportunities within the game.

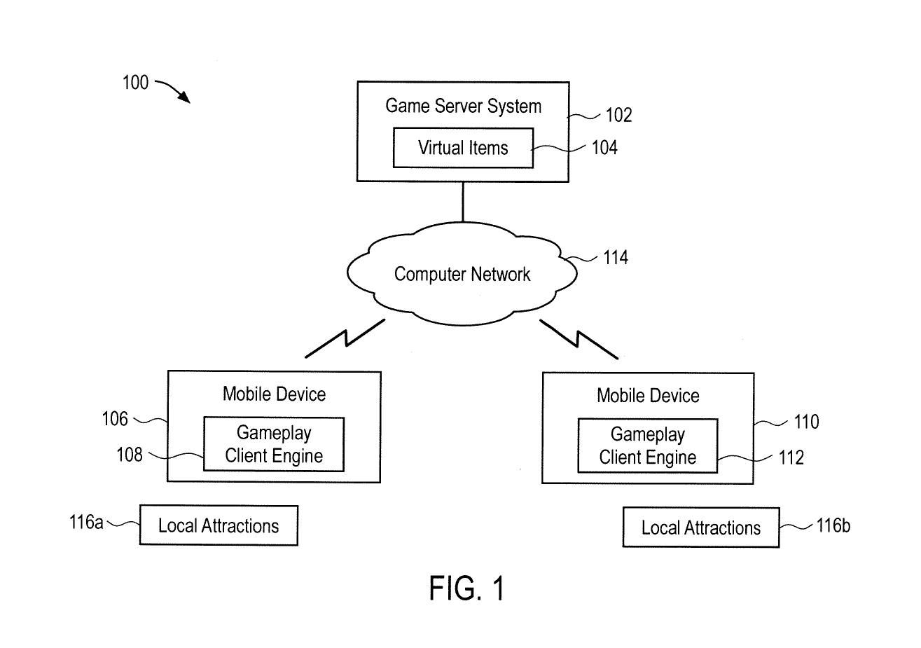

FIG. 1 is a block diagram of a gameplay system 100, according to some embodiments. The gameplay system 100 may include a game server system 102, a computer network 106, a mobile device 108, a mobile device 114, a local attraction 112, and a local attraction 118. The local attraction 112 may be proximate to the mobile device 108 and the local attraction 118 may be proximate to the mobile device 114. The game server system 102, mobile device 108, and mobile device 114 may be digital devices. A digital device is any device having a memory and a processor. For example, a digital device may be a personal computer, laptop, smart phone, media player, cellular phone, tablet computer, personal digital assistant, netbook, or the like.

In various embodiments, when a mobile device 108 initiates a game, the mobile device 108 may communicate with the game server system 102 via the computer network 106. The game server system 102 may provide one or more game services to the mobile device 108 to support gameplay.

The game server system 102 stores virtual items 104. A virtual item is any item depicted in a virtual environment that may be used in gameplay. The virtual item may comprise attributes (e.g., value for the game) and a real-world implication. For example, a mobile device 108 activates a game that allows for an interactive virtual environment. The interactive virtual environment may detect a local attraction 112 and allow a user of the mobile device 108 to interact with the local attraction 112. When the user interacts with the local attraction 112 in the virtual environment, the user may receive a virtual item (e.g., an object such as a food product, tool, roll of dollars, or weapon). The virtual item may be provided by the mobile device 108 or the game server system 102.

In one example, the game server system 102 may store virtual items 104. A user may play the game by checking into a local attraction. When the user checks-in, the user's digital device (e.g., mobile device 108) may provide check-in information with the game server system 102. The check-in information may include user identification information, game information, local attraction information, and/or any other information. User identification information may include a username, real name, or other user identifier. Game information may include the version of the game providing the check-in information, the level of the user, the virtual currency of the user, points of the user, an inventory of virtual items received by the user, a list of virtual items used by the user, or other game information. Local attraction information may include any identifying information regarding the local attraction generally (e.g., restaurant, theme park, or corporate headquarters), brand information (e.g., Sundance or World Cup playoffs), and/or specific information (Apple Inc. at 1 Infinite Loop in Cupertino, Calif.).

Once the game server system 102 receives the information, the game server system 102 may log the information (e.g., in a user profile), back up a profile of the user, and/or select one or more virtual items to provide to the user in exchange for the check-in. In various embodiments, the game server system 102 may utilize a series of data structures, such as tables, to provide a variety of different virtual items with different properties to the user at different check-ins. A user at a low level of the game may receive a different virtual item than a user who has obtained a high level.

In some embodiments, the virtual items may be very similar, but their attributes may be different. A attributes of the virtual object may include an additional number of check-ins for using the virtual object, an increase in virtual currency, or an increase in points. For example, a first level user and a 47^{th} level user may both receive “orange juice” as a virtual object. The orange juice virtual object may provide 10,000 points to the 1^{st} level user while the orange juice virtual object may provide 70,000 points to the 47^{th} level user.

Once one or more virtual objects are selected by the game server system 102, the game server system 102 may provide one or more object identifiers to the mobile device 108. The mobile device 108 may then present the virtual objects to the user during gameplay. In some embodiments, the digital device determines one or more virtual objects to present to the user without receiving the virtual object identifiers from the game server system 102 (e.g., if the game server system 102 is not available).

In some embodiments, the gameplay server system 102 includes one or more modules that provide information, applications, or resources to the client engines 108 and 114. The gameplay server system 102 may also host services that support applications executed on the client engines 108 and 114. For instance, the gameplay server system 102 may contain backend services such as support services or operating system services.

The virtual item 104 may have a real-world implication. A real-world implication provides information, services, or benefits outside of gameplay (i.e., in the real-world). Information provided outside of gameplay may include performance of a video or audio file, depictions of pictures, and/or displaying of information. Information may include, for example, a ringtone, audio file, image file, animation file, movie file, information regarding a good, service, person, real-world establishment, entertainment experience, video game, or the like. For example, a virtual item may include a food object from a brand-named restaurant. The user may receive an advertisement and/or ringtone of a song (e.g., a jingle) for the restaurant if desired, Services and benefits outside of gameplay may include coupons, discount codes, free offers for goods or services, limited-time offers, or the like.

In another example, the real-world implication of the virtual item 104 may include a message or information that is directed at generating revenue. In exemplary embodiments, the virtual item 104 may contain branding or advertising information. Branding information is information relating to a name, logo, slogan or design scheme associated with a product or service, while advertising information is information presented to persuade a mobile device user to take some action with respect to products or services. The branding or advertisement information in the virtual item 104 may take the form of audio content, video content, or a textual string.

The real-world implication of the virtual item 104 may include an offer to sell a product or service. The virtual item 104 may contain a coupon that a mobile device user can exchange for a financial discount or rebate on a product or service. The virtual item 104 may also contain a document code that a mobile device user can use to purchase a file such as an audio file, media file, or other document. In exemplary embodiments, the virtual item 104 contains a character string that is used to unlock a file such as an audio file, media file, or other document.

The real-world implication of the virtual item 104 may include providing an object that controls access to an attraction. The virtual item 104 may include a ticket that is used to grant admission to the attraction. The ticket may include a document code or a character string. The virtual item 104 may also include other items that provide admission to the attraction. In various embodiments, the virtual item 104 presents the user with a discount to the attraction. The attraction to which the virtual item 104 controls access may or may not be located near the mobile device user.

In various embodiments, the interactive gameplay limits the real-world implication of the virtual item 104 based on the fulfillment of one or more conditions or events. Conditions or events limiting the real-world implication of the virtual item 104 may relate to the user's course of actions in the interactive game. For example, certain attributes (e.g., benefits for gameplay) and/or real-world content (e.g., a ticket or discount) may only become accessible if the virtual item has been shared or traded to a predetermined number of people. Once the predetermined number has been reached, one or more of the sharing or trading people may benefit.

An exemplary condition may comprise a gameplay sequence in which the virtual item 104 is combined with other virtual items. Interacting with the virtual item 104 during gameplay may require a user to interact with one or more virtual items. The interactions may link the user to virtual items other than the virtual item 104. For example, a user may click an advertisement that directs him or her to a coupon to purchase the advertised item. In such a case, the virtual item 104 may have a real-world implication that is accessible only once the virtual item is combined with another virtual item.

An exemplary condition may also comprise transmitting or sharing the virtual item 104 to other users. Interacting with the virtual item 104 during gameplay may require a user to transmit the virtual item 104 to other users. Exemplary embodiments may provide a real-world implication only after transmission to another user.

The virtual item 104 may help increase or decrease a mobile device user's virtual credits in the interactive gameplay. Interactive gameplay may also contain routines or rules to select and provide the virtual item 104 based on a variety of factors, such as user location, likely proximity to a real-world item, environmental factors, economic factors, information about the user, the time of day, or completely at random.

The mobile device 108 houses a gameplay client engine 110 while the mobile device 114 houses a gameplay client engine 116.

The modules in the gameplay server system 102 may reside on a server, such as a web server, a database server, an enterprise server, or on a general purpose computer configured to provide services to the mobile devices 108 and 114.

Though shown residing in the digital server system 102, the virtual item 104 may also be stored in a location other than the digital server system 102. In exemplary embodiments, the virtual item 104 resides in a server other than the digital server system 102. For instance, the virtual item 104 may reside in a database server or a general purpose computer. The virtual item 104 may also be distributed across multiple servers with portions of the virtual item 104 residing in computers connected by the network 106. The virtual item 104 may also be stored on a mobile device. For example, one of mobile devices 108 and 114 may contain a CRSM, hard drive, or memory unit that contains all or portions of the virtual item 104.

In some embodiments, the computer network 106 links the gameplay server system 102 to the mobile devices 108 and 114. The computer network 106 may be any wired or wireless network. For example, the computer network 106 may comprise a wireless personal area network (WPAN), a wireless local area network (WLAN), a wireless metropolitan area network, and/or a wireless wide area network. The computer network 106 may also be a Global System for Mobile Communications (GSM) network, a personal communications service (PCS) network, a third generation (3G) wireless network, or a fourth generation (4G) network. The computer network 106 may be a Wireless Fidelity (Wi-Fi) network, a Worldwide Interoperability for Microwave Access (WiMAX) network, or other wireless network.

The computer network 106 may comprise a wired network without departing from the scope and the substance of the present inventive concepts disclosed herein. For instance, in exemplary embodiments, the computer network 106 comprises a wired local area network wired personal area network (PAN), a wired local area network (LAN), a wired metropolitan area network, or a wired wide area network. The connection to the wired network may occur through an Ethernet connection, digital subscriber line (DSL), a digital signal link (T1-T3 lines) or other connection.

Not all embodiments require the presence of the computer network 106. In exemplary embodiments, the computer network 106 is replaced with a bus or interconnection that connects the game server system 102 to one or more of the mobile devices 108 and 114. In such embodiments, the game server system 102, the bus or interconnection, and the connected mobile device (i.e., one of mobile devices 108 and 114) may reside on a single computer system. The game server system 102, the bus or interconnection, and the connected mobile device (i.e., one of mobile devices 108 and 114) may share a processor and memory. The single computer system may itself have a network connection allowing it to have network access to other computer systems, including mobile devices other than the mobile device on the single computer system.

In some embodiments, the mobile devices 108 and 114 may contain modules to provide the user access to the interactive gameplay. Although discussion herein will proceed with reference to the mobile device 108, it is noted that the mobile device 114 may incorporate modules (such as the gameplay client engine 116) and functions similar to the modules (such as the gameplay client engine 110) and functions disclosed regarding the mobile device 108. It is further noted that the mobile device 114 may incorporate modules and functions different from the modules and functions disclosed regarding the mobile device 108.

The mobile device 108 may provide a user interface to the interactive gameplay. The mobile device 108 may be a cellular phone, a tablet computer, a laptop computer, a personal digital assistant (PDA), or portable electronic device. The mobile device 108 may also be a personal computer (PC). The mobile device 108 may be a stand-alone gaming unit.

The mobile device 108 may have network access. For example, the mobile device 108 may include a wireless network card or an antenna to enable wireless network access. The mobile device 108 may be associated with a wireless data plan provided by a wireless network service provider. In various embodiments, the mobile device 108 is adapted to connect to a WPAN, a WLAN, a wireless metropolitan area network, or a wireless wide area network. The mobile device 108 may also be adapted to connect to a GSM network, a PCS network, a 3G network, or a 4G network. The mobile device 108 may be adapted to connect to a Wi-Fi network or a WiMAX network. In exemplary embodiments, the mobile device 108 has a network card (not shown) to connect to a wired network.

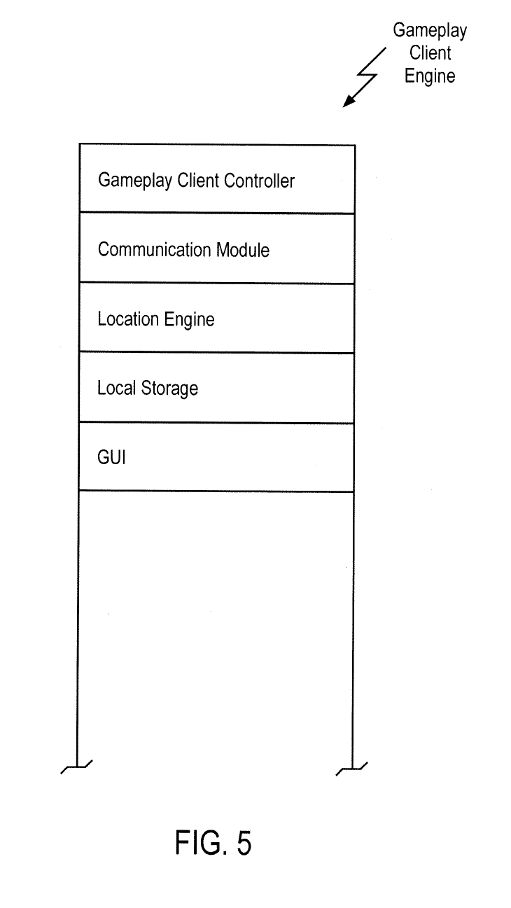

In some embodiments, the mobile device 108 houses the gameplay client engine 110. The gameplay client engine 110 may facilitate a client portion of the interactive gameplay. As such, the gameplay client engine 110 may contain a control module, a communication module, a module that provides the location of the mobile device 108, necessary storage, and a user interface. The gameplay client engine 110 may contain one or more components described in FIG. 5.

The local attraction 112 may have a specified location or an occurrence having a specified time. The local attraction 112 may have a location identifier, such as an address or a set of global positioning system (GPS) coordinates. The local attraction 112 may also have an associated time identifier to signify the duration of the local attraction 112.

Physically, the local attraction 112 may correspond to a business, residence, or other location. For instance, the local attraction 112 may be a coffee shop, a cruise ship, whole or part of a resort, a lounge, a nightclub, a karaoke bar, a store, whole or part of an airport, a restaurant, whole or part of a university, a park, or other location. The local attraction 112 may be a house, apartment, condominium, townhouse, or other residence. The local attraction 112 may have a location identifier, such as an address or a set of global positioning system (GPS) coordinates.

Temporally, the local attraction 112 may correspond to an event. For instance, the local attraction 112 may correspond to a musical concert or festival, a sporting event, a party, a gathering, an art exhibit, a scheduled outing, an excursion, or other occurrence. The event may have a specified duration and may recur. In exemplary embodiments, the local attraction 112 may occur only once.

Though FIG. 1 depicts only two mobile devices, namely mobile devices 108 and 114, various embodiments many include only one mobile device or more than two mobile devices. Additionally, embodiments may include groups of two or more mobile devices. The groups may access the content on the gameplay sever system 102 in a coordinated manner or may access this content in an uncoordinated manner.

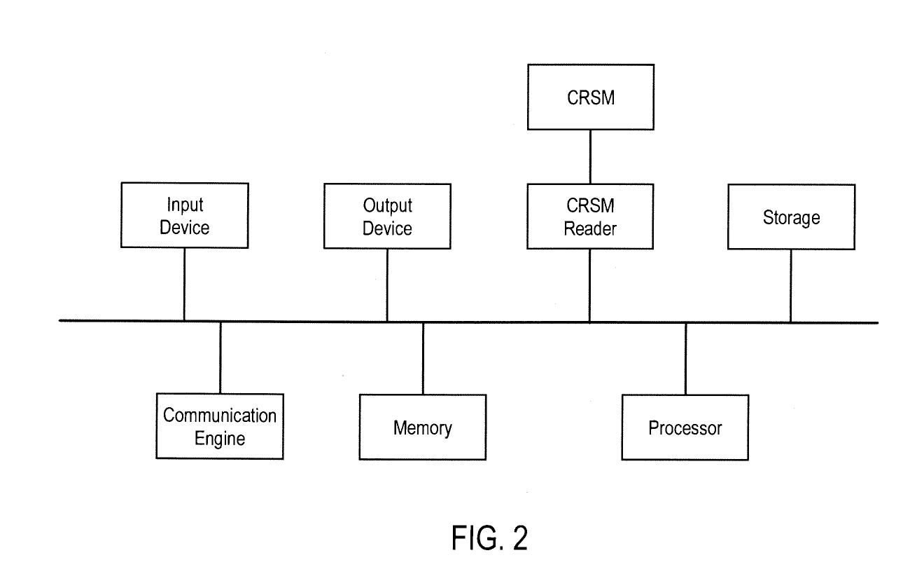

FIG. 2 is a box diagram of a digital device 200 in some embodiments. The digital device 200 may include an input device 202, an output device 204, a computer readable storage medium (CRSM) 206, a CRSM reader 208, storage 210, a communication engine 212, memory 214, a processor 216, and a bus 218. The digital device 200 may also include one or more clocks, arithmetic logic units (ALUs), input or output units, networking units, and other components, all not shown in FIG. 2. Some or all of the components in the digital device 200 may be housed in a single package. Some or all of the components in the digital device 200 may also share semiconductor die or packaging (not shown).

In some embodiments, the input device 202 is a device adapted to receive user input. The input device 202 may include a touch screen, a keyboard, a mouse, a pointer, or other peripheral device that can receive user input. In exemplary embodiments, the input device 202 is a capacitive touch screen that accepts input based on variations in surface capacitance. The input device 202 may be integrated into a mobile device user interface. For instance, the input device 202 may be integrated into the user interface of a mobile phone or tablet computer. The input device 202 may incorporate a keyboard (including a virtual capacitive keyboard) or other mechanism to receive text from a user. The input device 202 may also be adapted to receive graphical input, radio button and other button selections, menu selections, and other selections.

In exemplary embodiments, the output device 204 is a device adapted to display information to a user, an operator of the interactive game, or other person. The output device 204 may comprise a monitor such as a cathode ray tube (CRT), a liquid crystal display (LCD) screen, a light emitting diode (LED) screen, or a plasma screen. The output device may also be integrated into a touch screen. The output device 204 may be integrated into the graphical user interface (GUI) of a mobile device. For instance, the output device 204 may be integrated into the user interface of a mobile phone or tablet computer. In exemplary embodiments, the output device 204 is a capacitive touch screen that can also accept input based on variations in surface capacitance. The output device 204 may be capable of displaying text, graphics, buttons, menus, and other user interface items.

The CRSM 206 includes recording media used to store and retain digital data. The CRSM 206 may comprise a memory card, such as a Flash memory card. In various embodiments, the CRSM 206 is a Secure Digital (SD) card, an Extreme Data (xD) card, a Subscriber Identity Module (SIM) card, or a PC Card. The CRSM 206 may comprise an optical disc that is configured to encode the digital data in the form of pits and lands on an optical medium. The optical disc may accept read or write operations and may comprise one or more of a compact disc (CD), a digital video disc (DVD), a Blu-Ray disc, or other optical disc. The CRSM 206 may also include other forms of recording media.

The CRSM reader 208 may read or write data from the CRSM 206. The CRSM reader 208 may comprise a memory card reader. In exemplary embodiments, the CRSM reader 208 is adapted to read or write from a Secure Data (SD) card, an Extreme Data (xD) card, a Subscriber Identity Module (SIM) card, or a PC Card. The CRSM reader 208 may also be adapted to read or write from an optical disc, or other recording media.

In some embodiments, the storage 210 may comprise a non-transitive computer readable storage medium configured to store or retain data. In some embodiments, the storage 210 may comprise recording media used to store or retain data for a comparatively long time interval. For instance, the time interval of data storage by the storage 210 may be longer than the time that data is stored by the memory 214. However, in various embodiments, the time interval of data storage by the storage 210 may be approximately equivalent or shorter than the time that data is stored by the memory 214.

The storage 210 may comprise, for example, a hard drive or Flash medium. The storage 210 may be fixed or removable.

In exemplary embodiments, the storage 210 may comprise a removable hard disk that is connected to the other components in the digital device 200 through a universal serial bus (USB) connection. A system bus or other bus may alternatively couple the storage 210 to the other components in the digital device 200.

The storage 210 may store one or more data structures. Exemplary data structures may include one or more arrays, linked lists, hash-tables, tree structures, stacks, queues, or other data structures. The storage 210 may hold one or more databases. Each of the databases may hold individual database entries.

In some embodiments, the communication engine 212 is a network interface for facilitating information flow between the bus 218 and a network (e.g., computer network 106). The communication engine 212 may modify the format of data received from the bus 218 to a format suitable for transmission on a network (not shown). For example, the communication engine 212 may encapsulate bits received over the bus 218 to a data packet suitable for network transmission. The communication engine 212 may also modify the format of data received from the network to a format suitable for transmission over the bus 218. The communication engine 212 may decode network packets to form bits that are transmitted over the bus 218.

The communication engine 212 may be integrated into a wireless network adapter. The wireless network adapter may translate bits over the bus 218 to and from wireless data packets. In exemplary embodiments, the wireless network adapter comprises a wireless network interface card (NIC), a wireless repeater, or a wireless bridge. The wireless network adapter may comprise an antenna. The wireless network antenna may be implemented into the motherboard of the digital device 200 or may be part of an external card.

The communication engine 212 may be integrated into a wired network interface controller that translate bits over the bus 218 to and from data packets transmitted over a wired network. In various embodiments, the network interface controller may comprise a network interface card (NIC), a network adapter, or a LAN adapter. In exemplary embodiments, the network interface controller is implemented into the motherboard of the digital device 200. The network interface controller may also reside in an external card connected to the digital device 200.

In some embodiments, the memory 214 includes recording media used to store and retain digital data for a comparatively shorter time interval. For instance, the time interval of data storage by the memory 214 may be shorter than the time that data is stored by the storage 210. However, in various embodiments, the time interval of data storage by the memory 214 may be approximately equivalent or even longer than the time that data is stored by the storage 210.

The memory 214 may comprise volatile or non-volatile memory. In exemplary embodiments, the memory 214 may be volatile memory, such as static random access memory (SRAM), dynamic random access memory (DRAM), or other storage requiring a maintained power supply. The memory may be non-volatile memory, such as flash memory, read only memory (ROM), or other memory requiring no maintained power supply.

The memory 214 may store one or more data structures. Exemplary data structures may include one or more arrays, linked lists, hash-tables, tree structures, stacks, queues, or other data structures. The memory 214 may hold one or more databases. The databases may hold individual entries.

In exemplary embodiments, the processor 216 comprises a unit that is configured to execute the instructions of the operating system or programs running on the digital device 200. The processor 216 may carry out the primary functions performed by the digital device 200. The processor 216 may perform arithmetic, logical, input, or output operations.

The processor 216 may support a mobile operating system, such as iOS, the Android operating system, Linux-based mobile operating systems, the BlackBerry operating system, the Symbian operating system, the Microsoft Windows CE operating system, or other operating system. The processor 216 may also support application software. In exemplary embodiments, the processor 216 supports interactive gameplay.

The processor 216 may comprise one or more cores, each core reading and executing operating system or program instructions. The processor 216 may also comprise bus interfaces, or caches to efficiently manage the flow of instructions.

Moreover, the processor 216 may be integrated onto one or more integrated circuits (ICs). In various embodiments, the processor 216 may execute instructions on a general purpose processor, a microprocessor, an application specific integrated circuit (ASIC), or a field programmable gate array (FPGA).

As discussed herein, components in the digital device 200 of FIG. 2 may be incorporated into one of the devices shown in FIG. 1, such as the game server 102, the mobile device 108, or the mobile device 114. Any of the game server 102, the mobile device 108, and the mobile device 114 may include some or all of the components shown in FIG. 2.

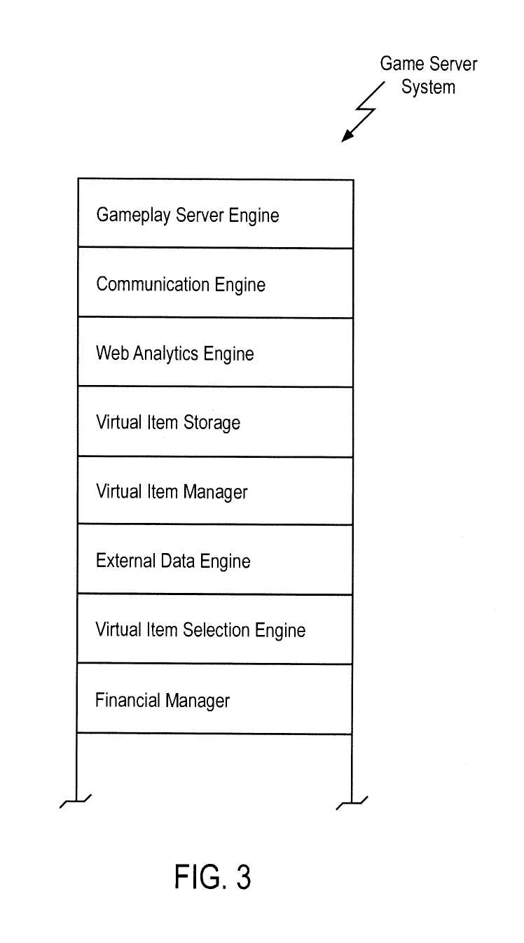

FIG. 3 is a block diagram of the game server system 102 in some embodiments. The game server system 102 comprises a gameplay server engine 302, a communication engine 304, an analytics engine 306, a virtual item storage 308, a virtual item manager 310, an external data engine 312, a virtual item selection engine 314, and a financial manager 316.

The gameplay server engine 302 may control the game server system 102 and execute functions that assist interactive location-based gameplay. In some embodiments, the gameplay client engine 110, the gameplay server engine 302, or both, include one or modules that store local attractions, detect a mobile device user's proximity to local attractions, and help select local attractions based on that proximity.

The communication engine 304 controls communication between the game server system 102 and the computer network 106. For example, the communication engine 304 includes a network interface for facilitating information flow between the game system server 102 and a network. The communication engine 304 may, in some embodiments, receive requests for virtual items from one or more gameplay client systems on different digital devices. The communication engine 304 may also provide one or more virtual item identifiers to the gameplay client systems.

The communication engine 304 may encode data into a format suitable for transmission over a network (not shown). The format may be a data packet. The data packet may include a destination identifier, such as the media access control (MAC) address of a mobile device. The communication engine 304 may employ other device identifiers without departing from the scope of the inventive concepts disclosed herein.

The communication engine 304 may also decode data received over the network into a format suitable for the game server system 102. In exemplary embodiments, the communication engine 304 receives data packets over the network. A received data packet may include a source identifier, such as a MAC address of a mobile device, or other device identifier. The received data packet may include a location identifier in the form of an address or a set of global positioning system (GPS) coordinates. A received data packet may also include a selected attraction. A selected attraction may correspond to a local attraction that a mobile device user has selected to check-into or otherwise interact with. In exemplary embodiments, the communication engine 304 is adapted to receive a data packet comprising interaction information from a mobile device user. Interaction information may correspond to a mobile device user's interaction with a specific virtual item.

The analytics engine 306 collects, analyzes, and/or prepares reports based on information received and/or generated during gameplay. In various embodiments, the analytics engine 306 may be used to identify users, groups, user actions, types of users, types of virtual goods, and other variables that tend to lead to engagement with a real world implication of a virtual item or purchases within the game. In various embodiments, the information from the analytics engine may be used to encourage purchases within the game for real money and/or engagement with the real world implications of various virtual items.

For example, the analytics engine 306 may track which virtual items are received by a user and whether the user has engaged with the virtual item. A virtual item is engaged when a user accesses the virtual item to view a virtual item display and/or interacts with a real world implication of the virtual item. For example, a virtual item may include a video link (e.g., to view product or advertising information of a real world product associated with the virtual item). If the user selects and view the video link, that information may be tracked by the analytics engine 306.

The analytics engine 306 may also track the locations and/or attractions which are visited (e.g., checked-in) by a variety of users and/or mobile devices. The analytics engine 306 may be used to perform acts to create opportunities to encourage users to engage in revenue generating opportunities (e.g., make purchases, engage with real-world content, or visit a local attraction. For example, a user that visits downtown Palo Alto, Calif., may visit any number of restaurants but may not yet have visited a specific yogurt establishment. By providing a virtual item that represents the establishment or the type of yogurt the yogurt establishment sells, the user may be reminded of the proximity of the yogurt establishment in the real world environment. These advertising opportunities may be monetized. Further, the analytics engine 306 may track combinations of events, actions, or the like that tend to lead to one or more users visiting a location or attending a local event.

Those skilled in the art will appreciate that the analytics engine 306 may also collect information regarding advertisement campaigns, virtual item selection, and the like to determine the success or failure of advertising programs. As a result, new virtual items may be created, real world implications modified, or similar actions conducted based on encouraging users to view advertisements, make purchases, or the like.

The analytics engine 306 may contain one or more modules to collect, analyze, or report the behavior of individual mobile device users and groups of mobile device users. To collect data on users, the analytics engine 306 may implement log-file analysis tools or local device tagging mechanisms.

To implement a log-file analysis tool, the analytics engine 306 may receive information from one or more mobile devices to create one or more log files. The analytics engine 306 may then employ a parser to parse specific locations, attractions, and interaction information associated with a mobile device user or group of mobile device users.

In some embodiments, the analytics engine 306 may implement local device tagging mechanisms to collect data at the mobile device level. At periodic intervals and/or when an amount of data has been collected, the mobile device may upload the information to the analytics engine 306. Those skilled in the art will appreciate that there are many ways to track information.

The analytics engine 306 may provide a basis for determining environmental or economic factors related to one or more mobile device users. Environmental factors are factors relating to a user's surroundings. Exemplary environmental factors may include weather, traffic, demographic factors, topological characteristics of a user's location, and other factors. Economic factors are factors relating to a user's finances or economic status. Exemplary economic factors may include social, cultural, or economic characteristics of the user. Exemplary economic factors may also include transactions into which one or more mobile device, users may have entered into or are likely to enter into as well as other financial factors,

The virtual item storage 308 is storage configured to store virtual items or virtual item identifiers. A virtual item identifier is an identifier that identifies a virtual item or a group of virtual items. In some embodiments, a virtual item identifier may be provided by the game server system 102 to the mobile device 108 during gameplay. The gameplay client engine 110 may provide the virtual item to the user of the mobile device 108 (e.g., display the virtual item during gameplay) based on the virtual item identifier. The virtual item storage 308 may be compatible with a recording medium such as the recording medium of the storage 210, shown in FIG. 2 and discussed above. The virtual item storage 308 may, for instance, comprise a magnetic storage medium such as a magnetic disk.

In exemplary embodiments, the virtual item storage 308 may store virtual items and/or virtual item identifiers as data structures. For example, virtual items may be stored as one or more of arrays, linked lists, hash-tables, tree structures, stacks, queues, or other data structures. Virtual items may also take the form of database entries in a database stored in the virtual item storage 308.

The virtual item manager 310 manages creation, selection, storage, and retrieval of virtual items and/or virtual item identifiers. In various embodiments, new virtual items may be created. For example, a game service provider may create one more virtual items including a depiction, identifier, real world implication, probability of receiving the virtual items, attributes, or the like using the virtual item manager 310. The virtual item manager 310 may store the newly created virtual item and/or virtual item identifier within the virtual item storage 310.

The virtual item manager 310 may also establish the probabilities and rules regarding one or more virtual items being provided to a user during gameplay. For example, a user at a certain level will likely be eligible to receive a virtual item with a lesser value (e.g., a virtual item that increases virtual currency by 20,000) and a user at a greater level will likely be eligible to receive a virtual item with a greater value (e.g., a virtual item that increases virtual currency by $80,000).

In various embodiments, a gameplay provider may use the virtual item manager 310 to store virtual items and probabilities of receiving virtual items based on a virtual economy offered by gameplay. The gameplay provider may maintain that virtual items should not destabilize the virtual economy (e.g., be limiting the number of virtual items players receive and by limiting the value of the virtual items to the players in the virtual world).

The virtual item manager 310 may also perform backup or recovery operations on the database in the virtual item storage 308. Moreover, the virtual item manager 310 may support scripts or modules that read or write virtual items to the virtual item manager 308.

The virtual item manager 310 may modify the attributes of the virtual item based on real-life events or events in interactive gameplay. For example, if a 30^{th} level user checks-in to a location, the virtual item manager 310 may adjust a variety of virtual items or a attribute for a group of virtual items such that the benefit of the virtual items will be appropriate for the user.

In exemplary embodiments, the virtual item manager 310 increases or decreases a the attributes of a virtual item, points offered at check-in, or virtual currency offered at check-in based on the user's proximity to one or more attractions (e.g., a proximity award). A proximity threshold is a predetermined distance to a local attraction. In some embodiments, virtual items may each be associated with a proximity threshold. In some embodiments, the gameplay client engine 110 may increase or decrease the points or virtual currency offered at check-in based on the user's proximity.

The virtual item manager 310 may also associate virtual items with other virtual items (e.g., parts) to allow users to create new virtual items. The virtual item manager 310 may provide rules that determine if the user has one part (i.e., virtual item) and needs another, that the probability to get that second virtual item to help complete a new virtual item increase.

The external data engine 312 allows outside providers to provide virtual item information to the gameplay server system 102. For example, an outside provider may view or authorize proposed advertisements, depictions of virtual items, and the like. In some embodiments, the outside provider may store advertisements, coupons, promotional campaigns, or the like to be used as real-life implications associated with one or more virtual items. Those skilled in the art will appreciate that, in some embodiments, the outside provider may use the virtual item manager 310 to create and store new virtual items in the external data engine.

The external data may include data from third-parties such as advertisers or businesses operating local attractions. For example, the external data engine 312 may store the cost of advertised items. The external data engine 312 may also store a discount for an advertised item or a discount for admission to a local attraction. The external data engine 312 may store the duration of an inducement, such as a specified period during which a discount is valid.

In exemplary embodiments, the external data engine 312 may interface with the analytics engine 306. In one example, the external data engine 312 may also notify the analytics engine 306 when events occur (e.g., whether a user has responded favorably to an advertisement, branding information, or has entered an attraction to which he or she received a ticket).

The virtual item selection engine 314 selects one or more virtual items or virtual item identifiers to be provided to the gameplay client engine 110. The virtual item selection engine 314 may select virtual items and/or virtual item identifiers based on attributes of specific virtual items as well as the location and other information about one or more mobile device users. The virtual item selection engine 314 may use many factors as a criteria for selecting, including, but not limited to characteristics of the user, associations, proximity to an attraction, environmental factors, economic factors, past behavior, analytics, and/or time.

The virtual item selection engine 314 may select virtual items based on attributes of specific virtual items. To this end, the virtual item selection engine 314 may implement scripts or modules that query virtual items within the virtual item manager 308 based on a set of virtual item selection criteria. For example, the virtual item selection engine 314 may select a virtual item based on the amount a third-party is willing to pay for an advertisement to reach the mobile device user.

In exemplary embodiments, the virtual item selection engine 314 may select virtual items based on characteristics of one or more mobile device users. For example, the virtual item selection engine 314 may select a virtual item based on whether a user is proximate to a local attraction such as a coffee shop, a cruise ship, whole or part of a resort, a lounge, a nightclub, a karaoke bar, a store, whole or part of an airport, a restaurant, whole or part of a university, a park, or other location. In exemplary embodiments, the virtual item selection engine 314 selects a virtual item based on whether a mobile device user is proximate in time or location to a local attraction such as a musical concert or festival, a sporting event, a party, a gathering, an art exhibit, a scheduled outing, an excursion, or other occurrence.

The virtual item selection engine 314 may select virtual items based on characteristics of mobile device users associated with a specific mobile device user. A second mobile device user is associated with a first mobile device user when the second mobile device user has a social, business, personal, or other relationship with the first mobile device user. A second mobile device user may be an online “friend” of a first mobile device user, for example.

In exemplary embodiments, the virtual item selection engine 314 selects a virtual item based on whether a second mobile device user associated with a first mobile device user is proximate to a local attraction such as a coffee shop, a cruise ship, whole or part of a resort, a lounge, a nightclub, a karaoke bar, a store, whole or part of an airport, a restaurant, whole or part of a university, a park, or other location. Additionally, the virtual item selection engine 314 may select a virtual item based on whether a second mobile device user associated with a first mobile device user is proximate in time or location to a local attraction such as a musical concert or festival, a sporting event, a party, a gathering, an art exhibit, a scheduled outing, an excursion, or other occurrence.

The virtual item selection engine 314 may select a virtual item based on environmental factors of one or more mobile devices or nearby attractions. Exemplary environmental factors may include weather, traffic, demographic factors, topological characteristics, as well as other factors.

The virtual item selection engine 314 may select a virtual item based on economic factors of one or more mobile devices or nearby attractions. Exemplary economic factors include social, cultural, or economic characteristics of the area near to local attractions, commercial or other transactions into which one more mobile device users have entered into or are likely to enter into, and other factors. In some embodiments, the virtual item selection engine 314 may select a virtual item based on social, cultural, or economic characteristics of an actual or likely mobile device user.

The virtual item selection engine 314 may select a virtual item based on data gathered from the analytics engine 306. As discussed above, in some embodiments, the analytics engine 306 collects, analyzes, or reports specific locations to which a mobile device user or group of mobile device users travel. Based on data from the analytics engine 306, the virtual item selection engine 314 may determine whether a user has responded favorably to an advertisement, branding information, or attraction. The virtual item selection engine 314 may present a user with virtual items to which the user is likely to respond favorably.

The virtual item selection engine 314 may select a virtual item using time-based factors. For instance, the virtual item selection engine 314 may select a virtual item based on the time of day. A virtual item may also be selected based on a day of a week, month, or year or on a specified date range. In exemplary embodiments, the virtual item selection engine 314 may select a virtual item at random.

The financial module 316 provides accounting in some embodiments. For example, the analytics engine 306 may track advertisements viewed and real world implication engagement by one or more users. Third-parties may enter into contracts for users to view and/or engage with advertising materials (e.g., the real world implication or event attendance). The financial module 316 may provide the necessary accounting to charge third-parties and track financial performance.

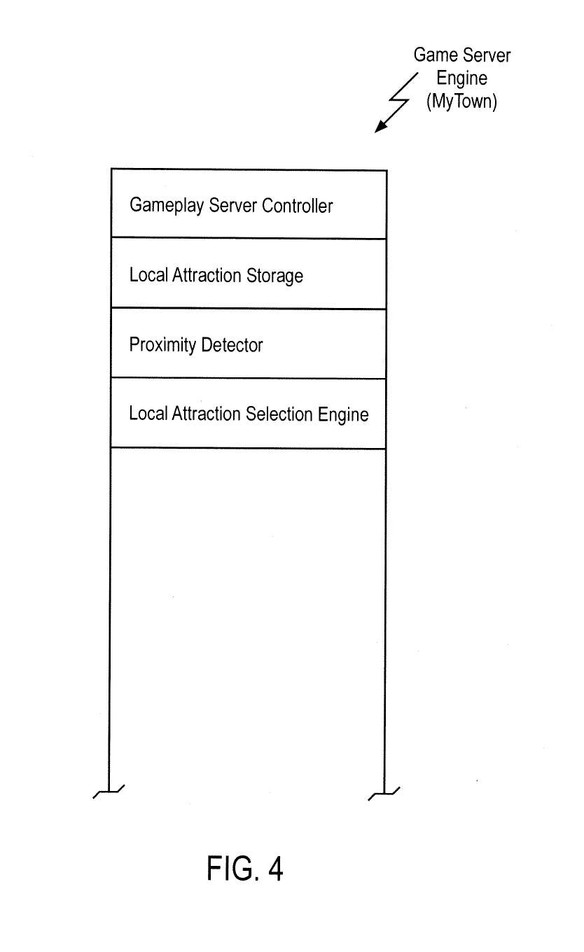

FIG. 4 is a block diagram of the gameplay server engine 302 in some embodiments. The gameplay server engine 302 may include a gameplay server controller 402, a local attraction storage 404, a proximity detector 406, a local attraction selection engine 408, game data storage 410, and location storage 412.

The gameplay server controller 402 may control the gameplay's interaction with the real world environment. In various embodiments, the gameplay server controller 402 may provide a list of local attractions to one or more mobile devices (e.g., mobile device 108 or mobile device 110).

The local attraction storage 404 stores one or more local attraction identifiers. In some embodiments, the gameplay server controller 402 may load local attractions from a variety of third party websites (e.g., Google Maps, Yahoo! Directories, and the like). The gameplay server controller 402 may also customize specific local attractions. For example, a particular business in New York may request that players of the game be encouraged to enter their real world facility (e.g., to check-in within the virtual world counterpart). The gameplay server controller 402 may customize the appearance of the virtual world counterpart and store the customization within the local attraction storage.

The local attraction storage 404 may hold one or more types of data structures. For example, the local attraction storage 404 may store arrays, linked lists, hash-tables, tree structures, stacks, queues, entries in a database or other data structures. In exemplary embodiments, the local attraction storage 404 stores a database with entries corresponding to local attractions.

Each local attraction may have a set of associated parameters. The parameters may operate to identify characteristics of the local attraction. The parameters may also be stored as entries in a database. For instance, a local attraction may have a name entry. A local attraction may further have a location entry represented by an address or a set of global positioning system (GPS) coordinates. In exemplary embodiments, a local attraction has a set of virtual credits or virtual items that can be associated with the local attraction. A local attraction may also have an Internet hyperlink or other parameters associated with it.

A local attraction may have a proximity threshold. As discussed above, a proximity threshold is boundary around a specific attraction that can be used to signify that a user is near the attraction. The proximity threshold may be stored as a number representing a distance around the attraction.

The local attraction storage 404 may store a list of attractions within a specified geographic region. For instance, the local attraction storage 404 may comprise a list of the attractions that reside within a given city, county, state, country, or arbitrarily selected geographic zone. The local attraction storage 404 may update the list of attractions when a user enters a different region.

The local attraction storage 404 may store a list of attractions within a specified time interval. For example, the local attraction storage 404 may comprise a list of the attractions that occur during a given day, week, month, year, or arbitrarily selected time period. The local attraction storage 404 may update the list of attraction periodically or at arbitrary time intervals.

The proximity detector 406 establishes the proximity of the users to local attractions before when the local attractions may be identified to the user. For example, when a user attempts to check-in, the user may receive a listing of all local attractions that are within 20 meters of the mobile device 108. The list may be sorted based on proximity, featured attraction, user preference, past player behavior, or the like. The proximity threshold (e.g., the minimum distance to the local attraction needed before the local attraction will appear in the listing) may be different for different attractions. In some embodiments, the proximity detector 406 establishes the proximity for different attractions or groups of attractions. For example, if the player is within Southern California, they may be able to check-into Disneyland or a Disneyland theme park. The player, however, may not have the option to check-in to a downtown Marriott unless the player is within 30 feet of the establishment.

The local attraction selection engine 408 may select one or more local attractions based on the mobile device user's proximity, past player behavior, featured locations, and/or other criteria. In various embodiments, the local attraction selection engine 408 queries the local attraction storage 404 for a list of local attractions that fall within a specified geographic range. The geographic range may relate to the proximity threshold. For instance, in exemplary embodiments, the geographic range may have a radius equal to the proximity threshold or may have a radius that is an integer multiple of the proximity threshold. The local attraction selection engine 408 may therefore provide a list of local attractions that are proximate to the mobile device user.

The local attraction selection engine 408 may also select local attractions based on past player behavior. For example, if the player tends to visit restaurants and night clubs but not organizations, then lists may be sorted on the type of establishments that the player is apt to visit to further tie the player's activities in the real world to the virtual world.

In some embodiments, the local attraction selection engine 408 sorts listings based on featured listings. For example, Borders Bookstores may enter into an agreement such that their bookstores may be prominently displayed for a determined geographic area to encourage players to enter the bookstore. Those skilled in the art will appreciate that there are many criteria that may be used to sort the local attractions.

In some embodiments, the local attraction selection engine 408 determines criteria for selecting local attractions and provides the criteria to an attraction selection engine on the mobile device 108. For example, the general location of a player may be known. All possible locations including criteria for presenting the locations in a list during check-in, may be provided to the mobile device 108 (e.g., via download or streaming).

In some embodiments, the local attraction selection engine 408 may implement search filters that query the local attraction storage 404 for a mobile device user's habits relating to visiting attractions. The local attraction selection engine 408 may create queries based on data gathered from the analytics engine 306, shown in FIG. 3. The analytics engine 306 may provide, as discussed above, whether a mobile device user has check-into a specific attraction. The analytics engine 306 may also provide the frequency of cheek-ins and a mobile device user's check-in patterns.

In exemplary embodiments, the local attraction selection engine 408 queries the local attraction storage 404 for economic factors relating to a specific mobile device user. As discussed above, economic factors are factors relating to a user's finances or economic status. The local attraction selection engine 408 may therefore query the local attraction storage 404 for social, cultural, or economic characteristics of the user or transactions into which one or more mobile device users may have entered into or are likely to enter.

The local attraction selection engine 408 may also query the local attraction storage 404 for environmental factors relating to a specific mobile device user. As discussed above, environmental factors are factors relating to a user's surroundings. The local attraction selection engine 408 may therefore query the local attraction storage 404 for weather, traffic, demographic factors, topological characteristics of a user's location, and other factors.

The game data storage 410 may store game data associated with the game. In some embodiments, the game data storage 410 may be used to back-up user's game play (e.g., in the event data in the mobile device is lost or a user purchases a new device and wishes to transfer the data to the new device). The game data storage 410 may be compatible with a hard disk employing, for instance, semiconductor storage, magnetic storage, optical storage, or other storage medium. The game data storage 410 may use fixed or removable storage units. The game data storage 410 may store one or more data structures, such as one or more arrays, linked lists, hash-tables, tree structures, stacks, queues, entries in a database or other data structures. The game data storage 410 may include a database holding data relating to a specific game or to games played by a specific user or group of users.

The location storage 412 may store data relating to the location of a user's device. The location storage 412 may store local attractions, local attraction identifiers, information associated with local attractions (e.g., GPS coordinate, address, phone number, type of business, and hours of operation), value of local business (e.g., in-game purchase price and rental value), the like. The location storage 412 may be compatible with a hard disk employing, for instance, semiconductor storage, magnetic storage, or optical storage. The location storage 412 may be compatible with fixed or removable storage units. The location storage 412 may store one or more data structures, such as one or more arrays, linked lists, hash-tables, tree structures, stacks, queues, entries in a database or other data structures. The location storage 412 may include a database holding entries relating to specific user locations. User locations may be represented in a variety of forms, including character strings and objects.

FIG. 5 is a block diagram of a gameplay client controller 502 in some embodiments. The gameplay client engine 110 includes a gameplay client controller 502, a communication module 504, a location engine, 506, a local storage 508, and a graphical user interface (GUI) 510. The communication module 504 is a network interface for facilitating information flow between the gameplay client engine 110 and a network (e.g., the computer network 106).

The communication module 504 may encode data into a format suitable for transmission over a network (not shown). The format may be a data packet. The data packet may include a source identifier, such as the media access control (MAC) address, of a mobile device. The communication module 504 may employ other device identifiers without departing from the scope of the inventive concepts disclosed herein. The packet may also include a location identifier in the form of an address or a set of GPS coordinates. The packet may further include a selected attraction that corresponds to a local attraction that a mobile device user has selected to check-into or otherwise interact with. The packet may further be adapted to contain interaction information from a mobile device user. As will be discussed further below, interaction information may correspond to a mobile device user's interaction with a specific virtual item.

The communication module 504 may also decode data received over the network into a format suitable for the gameplay client engine 110 to process. In exemplary embodiments, the communication engine 304 receives data packets over the network. The received data packets may include a destination identifier, such as the media access control (MAC) address of a mobile device. The received packet may contain other destination identifiers without departing from the scope of the inventive concepts disclosed herein. The received data packet may also include a list of attractions. The received data packet may further include one or more virtual items taken from the virtual item storage 308 or the virtual item manager 310.

The location engine 506 provides the location of the mobile device containing the gameplay client engine 110. The location engine 506 may interface with a GPS receiver (not shown) or other navigational module. The location engine 506 may receive a location identifier comprising an address or one or more GPS coordinates from the GPS receiver or navigational module. In exemplary embodiments, the location engine 506 employs buffers or filters to ensure accurate and efficient processing of navigational information. The location engine 506 may also be adapted to accept user input from the GUI 510 to override the location identifier received from the GPS receiver or other navigational module. In some embodiments, the location engine 506 determines a location through triangulation of cellular towers, identification of wireless access points, or the like.

The local storage 508 may operate as a cache or short term memory storage. The local storage 508 may store the present location and a past history of locations of the mobile device, virtual credits, attractions, one or more virtual items, and other data. The local storage 508 may comprise a hard disk employing, for instance, semiconductor storage, magnetic storage, or optical storage. The storage 508 may comprise fixed or removable storage units.

The GUI 510 displays the gaming interfaces with the user of the mobile device containing the client engine 110. The GUI 510 may list a user's virtual credits, attractions, virtual items, and other information. The GUI 510 may also accept input from a user from, for instance, a touch screen, a keyboard, a mouse, a pointer, or other input device.

The GUI 510 may link a user to an online store. The GUI 510 may be integrated into the interface of a mobile operating system, such as iOS, the Android operating system, Linux-based mobile operating systems, the BlackBerry operating system, the Symbian operating system, the Microsoft Windows CE operating system, or other operating system. Non-graphical user interfaces may also be employed without departing from the intent and scope of embodiments disclosed herein.

In various embodiments, the gameplay client engine 110 may display the game interface to the user of the mobile device, determine the location of the mobile device, store possible local attractions, provide a subset of those attractions to the user based on the location of the mobile device, receive a check-in indication from the user, and provide check-in information to the game server system 102. The gameplay client engine 110 may receive one or more virtual items or virtual item identifiers. The gameplay client engine 110 may present one or more virtual items to the user via the GUI 510. The gameplay client engine 110 may also provide the real-world implication of the virtual items by performing an audio file, providing a data file, downloading a ringtone, or the like.

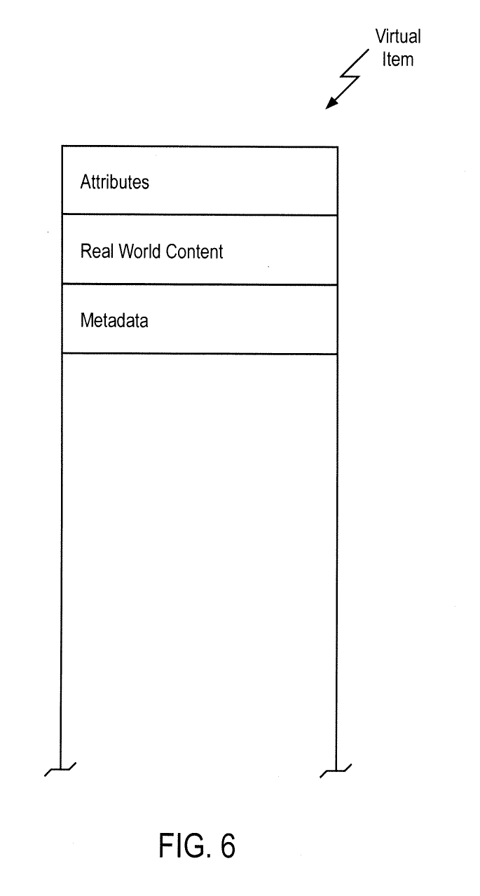

FIG. 6 is a block diagram of a virtual item 600 in some embodiments. The attributes 602 may contain interactive gameplay data. In various embodiments, the attributes 602 may comprise virtual currency or credits that a user may earn when using or selling the virtual item, points that a user may earn when using the virtual item, or check-ins earned for using the virtual item. Attributes may be any benefit of a virtual item that may be used during gameplay.

In some embodiments, the virtual item 600 comprises real-world content 604. The real-world content 604 may include aspects of the real world (i.e., the physical world) that are integrated into components or parts of gameplay. For instance, the real-world content 604 may comprise any real-world implication.

In some embodiments, the virtual item 600 may include metadata 606. Metadata 606 comprises data providing information about one or more aspects of the virtual item 600. In exemplary embodiments, metadata 606 may include: the time, date or location the virtual item 600 was created, the entity that created the virtual item 600, the process or standards used to create the virtual item 600, and the relationship between the virtual item 600 and other virtual items. The metadata 606 may also contain information about the size or usability of the virtual item 600 as well as specific users authorized to access the virtual item 600.

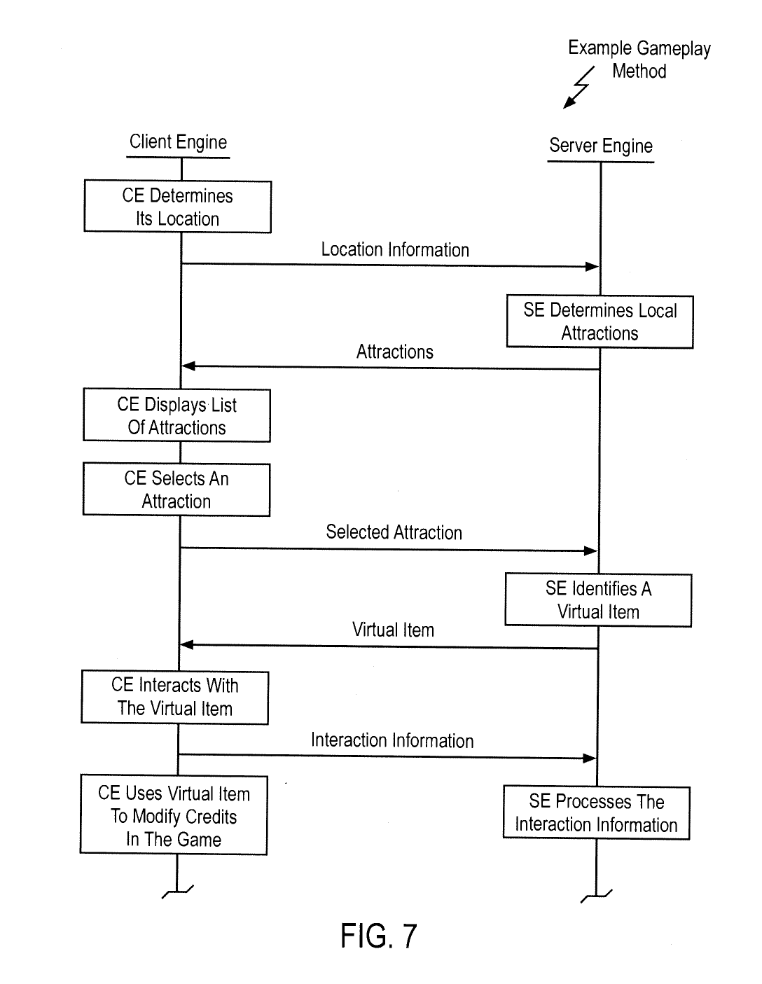

FIG. 7 shows a gameplay method 700 in some embodiments. In some embodiments, the gameplay method 700 may be executed between a client engine 500 and a server engine 302. The gameplay method 700 may comprise steps 702-726. Although the steps 702-726 are sufficient to enable some embodiments, one or more of steps 702-726 may be omitted. Exemplary gameplay methods may also include additional steps without departing from the scope of the inventive concepts disclosed herein. Any of steps 702-726 may include sub-steps that are not shown in FIG. 7. The method depicted in FIG. 7 will be discussed with reference to the modules illustrated in FIGS. 1-6.

In step 702, the client engine 500 determines the location of the mobile device. In some embodiments, the location engine 506 (shown in FIG. 5) may obtain location information from a GPS receiver or other navigational module. In exemplary embodiments, the location information includes a location identifier comprising one or more addresses or one or more GPS coordinates.

The client engine 500 provides the location information to the server engine 302 in step 704. In one example, the communication engine 304 (shown in FIG. 3) may receive and decode the location identifier and the source identifier from the data packet. The communication engine 304 may transmit the location identifier and the source identifier to the gameplay server engine 302 for further processing. Additionally, the communication engine 304 may cache the location identifier and the source identifier in the local storage 508. The local storage 508 may store the location identifier and the source identifier as database entries. In exemplary embodiments, the communication engine 304 stores the location identifier and the source identifier in the location storage 412 (shown in FIG. 4). The location storage 412 may store the location identifier and the source identifier as database entries.

In step 706, the server engine 302 determines local attractions and provides the attractions to the client engine 500 in step 708. In some embodiments, the gameplay server controller 402 (shown in FIG. 4) may direct the proximity detector 406 to query the local attraction storage 404 for a list of attractions that are proximate to the provided location information. The proximity detector 406 may employ geographical queries based on the requesting client's location or time-based queries.

In exemplary embodiments, the proximity detector 406 compares the location information with a location field within a master list of attractions stored in the local attraction storage 404. For example, the proximity detector 406 may compare GPS coordinates or addresses to determine how far a specific mobile device is from one or more local attractions. The proximity detector 406 may also obtain a list of attractions that reside within a specified distance (such as a specified radius) of the provided location information.

The gameplay server controller 402 may direct the local attraction selection engine 408 to select some or all of the attractions from the list of attractions. In exemplary embodiments, the local attraction selection engine 408 applies additional search criteria, such as a comparison of the request time to a time field associated with each attraction in the master list of attractions stored in the local attraction storage 404. The local attraction selection engine 408 may obtain from the local attraction storage 404 a list of attractions that occur within a specified time. The local attraction selection engine 408 may apply search criteria derived from the analytics engine 306 (shown in FIG. 3) to customize a list of attractions based on analytics derived from a mobile device user's behavior.

In step 708, the server engine sending attractions to the client engine. In some embodiments, a server-side communication module 304 (shown in FIG. 3) may send the selected list of attractions to a client-side communication engine. The client-side communication engine, such as the communication module 504 (shown in FIG. 5) may receive and decode the selected list of attractions. The communication module 504 may also transmit the selected list of attractions to the gameplay client controller 502.

In various embodiments, the client engine 500 will cache or store location information within the mobile device or client engine 500. The attractions provided by the server engine 302 may comprise a list of attractions within a predetermined distance of the client engine 500 (e.g., 5 miles). The next time a player wishes to check-in or view local attractions, the client engine 500 may determine that if the client engine 500 is within the predetermined distance, then attractions are retrieved from cache. If the client engine 500 location has moved, however, (e.g., a player has driven in their car to another town), then new attractions may be provided upon request of the client engine 500.

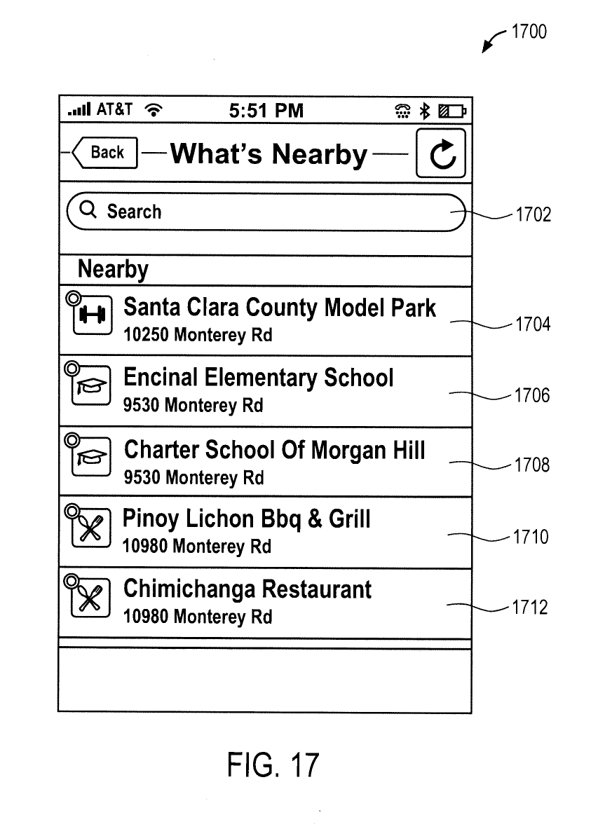

In step 710, the client engine 500 displays a list of attractions to the user. In some embodiments, the gameplay client controller 502 (shown in FIG. 5) may configure the GUI 510 to display the selected list of attractions to the user. The GUI 510 may display the selected list of attractions in a tabular format, textual format, as part of an annotated map, or other format consistent with the display of a list of items. The GUI 510 may also display other information, such as contact information, hours, and ratings, any of which may be related to the list of attractions. To optimize processing, the gameplay client controller 502 may write the selected list of attractions into the local storage 508. In exemplary embodiments, the client engine may list nearby attractions, as shown in FIG. 17.

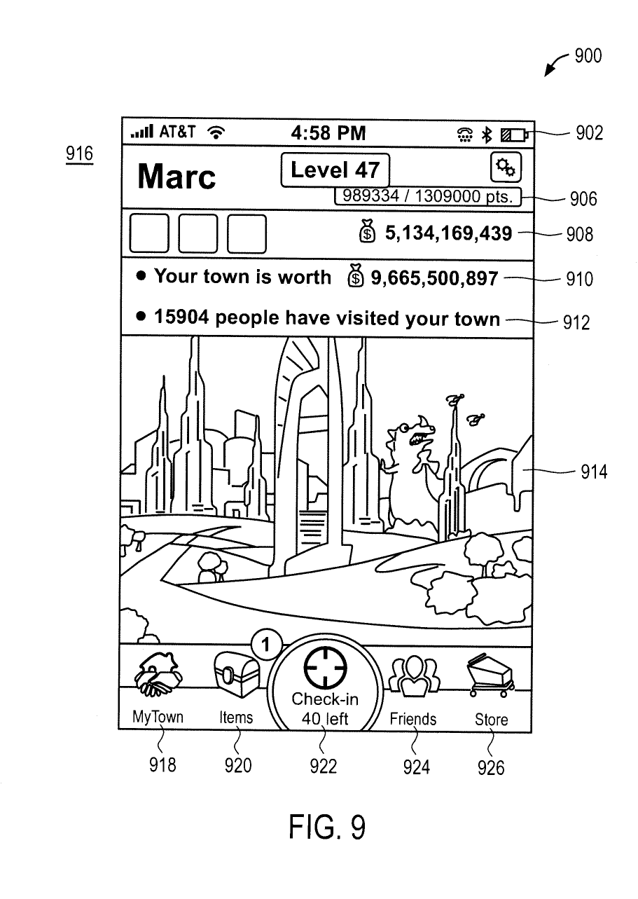

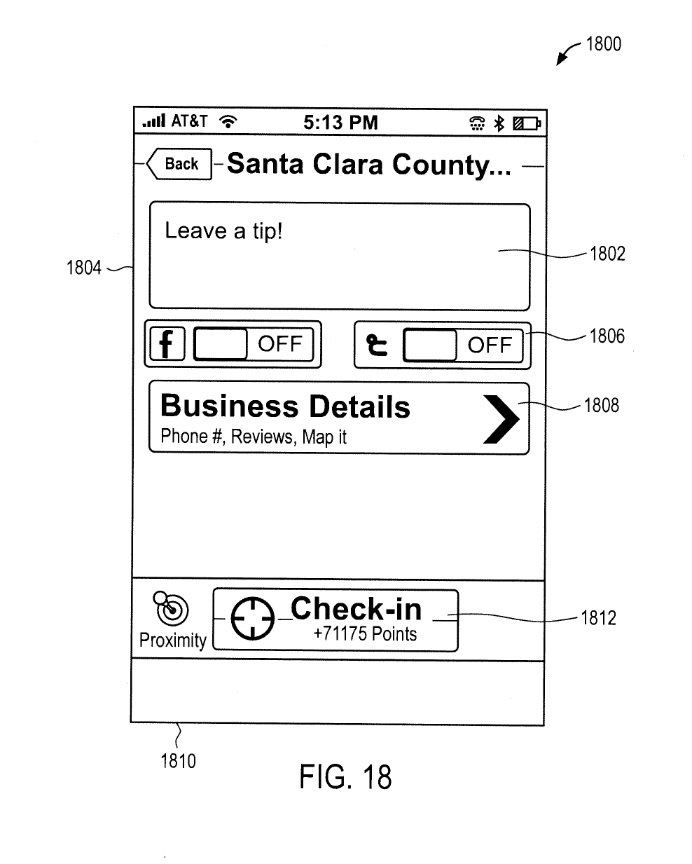

In step 712, the client engine selects an attraction. For example, the gameplay client controller 502 may configure the GUI 510 to accept an attraction that a mobile device user has selected. For instance, the GUI 510 may accept a touch screen selection for one or more of the list of attractions. In exemplary embodiments, the GUI 510 provides a radio button that enables a user to check-into the selected attraction. For example, FIGS. 9 and 18 show check-in buttons 922 and 1812, which allow users to specific attractions.

The GUI 510 may also accept a character string corresponding to the selected attraction. For instance, in exemplary embodiments, a user may type in the name of a specific attraction. The GUI 510 may further have auto-complete features, which allow automatically complete the name of an attraction based on a name partially typed by the user.

The GUI 510 may provide a user only a limited number of “check-ins” to a given attraction or to a total number of attractions. For example, the check-in button 922 in FIG. 9 shows a limited number of forty check-ins allowed. The “check-in” may require a user to use, exchange, or purchase virtual credits or virtual points. After the user has used his or her forty check-ins, the interactive game may prompt the user to purchase or trade check-ins for additional virtual credits.

During interactive gameplay, the user may gain virtual credits or virtual points for checking into one or more specific locations. For instance, as shown in FIG. 18, a user may gain 1175 virtual points for checking into an attraction using the check-in button 1812. The gameplay client controller 502 may save information relating to the selected attraction into the local storage 508.

In step 714, the client engine 500 sends a selected attraction to the server engine 302. In some embodiments, the communication module 504 (shown in FIG. 5) may send the selected attraction to a server engine, such the gameplay server engine 302 (shown in FIG. 3). The communication module 504 may send the selected attraction to the gameplay server engine 302 via the communication engine 304. In exemplary embodiments, the communication module 504 may also send a device identifier to the gameplay server engine 302.

Those skilled in the art will appreciate that, in some embodiments, instead of providing attraction information, the client engine 500 provides a virtual item request to the server engine 302. The virtual item request may identify the user or information about the user (e.g., level of the user, points, previously received virtual items, and the like).

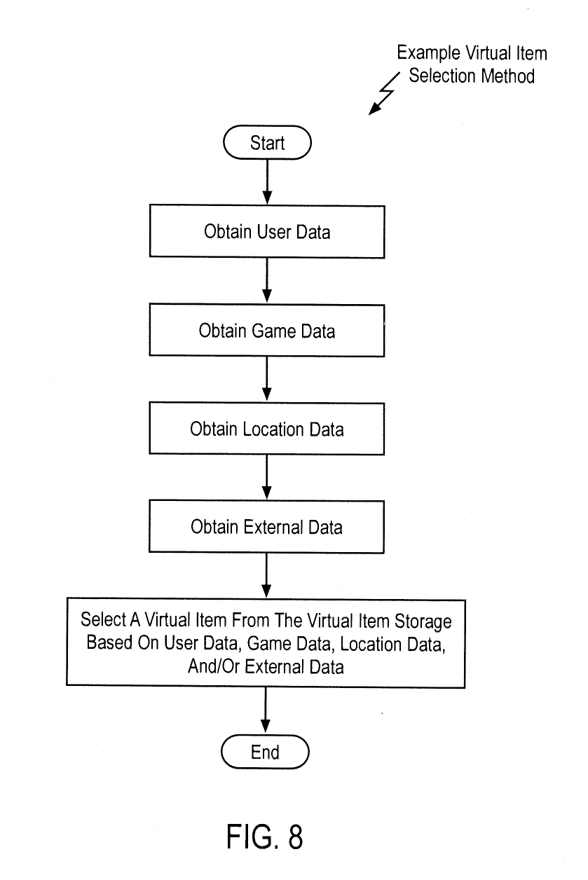

In step 716 the server engine 500 identifies one or more virtual items. In various embodiments, the server engine 500 determines a virtual item based on past virtual items received, level of the user, virtual currency currently possessed by the user, and the like. This step if further discussed in FIG. 8.

In step 718, the server engine 302 sends the virtual item identifier to the client engine 500. In some embodiments, a server-side communication module 304 (shown in FIG. 3) may provide the virtual item identifier to a client-side communication engine. The client-side communication engine, such as the communication module 504 (shown in FIG. 5) may receive the virtual item identifier. The communication module 504 may also transmit the virtual item identifier to the gameplay client controller 502. The gameplay client controller 502 may, in turn, transmit the virtual item to the GUI 510 so that the GUI 510 can display to a user an interface incorporating the virtual item.

In step 720, the client engine 500 interacts with the virtual item. For example, when a user interacts with the virtual item, the user may access real-world content such as a video, product information, or the like. The interaction information may be provided by the client engine 500 to the server engine 302 in step 722.

In step 722, the client engine 500 sends the interaction information to the server engine 302. In some embodiments, the communication module 504 (shown in FIG. 5) may send the interaction information to a server engine, such the gameplay server engine 302 (shown in FIG. 3). The communication module 504 may send the interaction information to the gameplay server engine 302 via the communication engine 304. The interaction information may identify the user, the client engine 500, the mobile device, the virtual item, and/or the real world content that was accessed by the user.

In step 724, client engine uses the virtual item to modify virtual credits (e.g., receive points, virtual currency, and/or check-ins) in gameplay. In some embodiments, the gameplay client controller 502 (shown in FIG. 5) updates virtual credits stored in the local storage 508 based on the interaction information.

In step 726, the server engine processes the interaction information, In some embodiments, the analytics engine 306 assesses the actions taken by the user to identify users, groups, or behavior that is likely to lead to engagement with real-world content. In some embodiments, the gameplay server engine 302 may direct the virtual item manager 310 to modify or update virtual items in the virtual item storage 308 to further encourage real-world content interaction. The gameplay server engine 302 may further direct the virtual item selection engine 314 to select a new virtual item based on the interaction information, modify selection criteria for virtual items, or modify web analytic criteria within the analytics engine 306. The gameplay server engine 302 may also use the interaction information to modify or update game data and future selection of local attractions.

Some embodiments may be integrated into a mobile device application that is compatible with a mobile operating system. Mobile operating systems may include operating system such as iOS, the Android operating system, Linux-based mobile operating systems, the BlackBerry operating system, the Symbian operating system, the Microsoft Windows CE operating system, and other operating systems.

FIG. 8 is a method of the virtual item selection method 716 in some embodiments. Various embodiments may omit one or more of steps 802-810 or may include additional steps not shown in FIG. 8. Further, any of steps 802-810 may also include sub-steps that are not shown in FIG. 8.

In step 802, the virtual item selection engine 314 obtains user data. The user data may comprise a user identity, achievements, web traffic patterns, user's behavioral patterns, or the popularity of specific locations relating to a specific mobile device user.

In step 804, the virtual item selection engine 314 obtains game data. In some embodiments, the virtual item selection engine 314 may obtain game data from the game data storage 410 within the gameplay server engine 302. The game data may comprise a user's level, a user's points, game time played by the user, or the like.

In step 806, the virtual item selection engine 314 obtains location data. In exemplary embodiments, the virtual item selection engine 314 may obtain location data from the location storage 412 within the gameplay server engine 302. In various embodiments, the location data may include an address or a set of GPS coordinates and may correspond to the physical location of the mobile device user. Those skilled in the art will appreciate that this step may be optional.

In step 808, the virtual item selection engine 314 obtains external data. External data may affect the criteria with which one or more virtual item may be selected. In some embodiments, a third-party may indicate a preference for individuals of a certain demographic and physical location to receive a branded virtual item.

In step 810, the virtual item selection engine 314 selects a virtual item from the virtual item storage based on user data, game data, location data, or external data. As discussed herein, the virtual item selection engine 314 may select virtual items based on one or more factors, such as: attributes of specific virtual items, the amount a third-party is willing to pay for an advertisement to reach the mobile device user, characteristics of one or more mobile device users, attractions proximate to one or more mobile device users, characteristics of mobile device users associated with a specific mobile device user, whether a second mobile device user associated with a first mobile device user is proximate to a local attraction, environmental factors of one or more mobile devices or nearby attractions, economic factors of one or more mobile devices or nearby attractions, data gathered from the analytics engine 306 (shown in FIG. 3), time-based factors, or other factors.

FIG. 9 shows an initial screen 900 in some embodiments. In various embodiments, a user may activate the game with a digital device and be presented with the initial screen 900. The initial screen 900 identifies the user (e.g., by name, username, nickname, or other identifier). A user may interact with initial screen 900 in the context of a mobile operating system interface 902. The initial screen 900 may show a level 904, points 906, virtual currency 908, a town value 910, visitor activity 912, town imagery 914, and a username 916. The initial screen 900 may also show a town link 918, an item link 920, a check-in button 922, a friend link 924, and a store link 926.

The level 904 indicates a level that the player has achieved. In this example, the user with a username “Marc” has achieved a level of 47. The user may increase levels as the user gains points 906. The user may receive points 906 and virtual currency 908 by checking into various local attractions and/or by using one or more virtual items. For example, a user may check-in to a particular local attraction and use a virtual item from an inventory of virtual items. By checking in and using a virtual item, the user may earn points 906 and virtual currency 908. In some embodiments, the user may use a virtual item without checking into a local attraction to receive points 906 and virtual currency 908.

The town value 910 represents the value in virtual currency of a user's town. In some embodiments, the virtual currency 908 represents virtual currency that is available to be immediately used. The town value 910 represents the current worth of a user's particular virtual town.

In various embodiments, a user may purchase one or more different local attractions with virtual currency 908. The purchase value of the local attraction may be based on any number of factors. For example, the purchase value of the local attraction may be based on the number of users who have purchased the local attraction in their particular game and/or the number of virtual users who have checked-in to the local attraction. Once a user purchases a local attraction, the value of the local attraction may increase or decrease based on the number of users who have purchased the local attraction in their particular game and/or the number of virtual users who have checked-in to the local attraction. The user may sell the local attraction for a profit or loss.

In various embodiments, multiple users may purchase the same local attraction in different games. For example, a first user may purchase the Google Complex in Mountain View, Calif., in their virtual game. A second user may also purchase the Google Complex in a different virtual game. The value of the Google Complex may be based on the number of different “owners” of the Google Complex aggregated over the different games. In some embodiments, ownership of a local attraction may be limited to a single user or a limited number of users.

Visitor activity 912 represents the number of visitors who have checked-into one or more different properties of a user's virtual town. Visitor activity 912 may increase when a user checks-in to owned property. For example, if a player owned the Apple Store in Palo Alto, Calif., as a part of their virtual town, the visitor activity 912 may increase as different users check-in to the Apple Store in Palo Alto. In some embodiments, the visitor activity 912 may increase as other players visit each other's virtual towns in the game environment.

The town imagery 914 is an image that depicts the virtual town. Each building in the virtual town may represent a local attraction that the user has purchased. The player may also “upgrade” property thereby receiving a different representation (e.g., a larger or more futuristic representation) of buildings within the user's virtual town.

The town link 918 allows a user to access the town interface to modify attributes of specific buildings in his or her virtual town, or attributes of his or her virtual town. For instance, a user may use the town link 918 to purchase additional properties to add to the user's virtual town. The user may also use the town link 918 to sell properties, upgrade properties, and receive rental income. In exemplary embodiments, the user utilizes the town link 918 to build items, decorate properties in the user's virtual town, or the like.

The item link 920 allows a player to access a virtual item inventory which includes a list of available virtual items that may be used by the player. The item link 920 may show pending virtual items, which are those virtual items that the user has received but not actively used in gameplay. As shown in FIG. 9, the item link 920 associated with the user Marc has one pending virtual item.

The check-in button 922 allows the user to access a check-in interface that allows a user to check-in to a local attraction. Gameplay may limit the user to a specified number of “check-ins.” For example, the initial screen 900 indicates that Marc can check-in 40 more times. The limitation may govern the check-ins allowed for a given day, period of time, or the number of check-ins for the user's account in general. In some embodiments, limiting a user to a specified number of check-ins enhances gameplay by allowing players to strategically use the limited number of check-ins or buy or sell additional check-ins from other users. In some embodiments, the user is limited to forty check-ins per day.

The friend link 924 allows a user to visit different virtual towns by other players. The store link 926 allows a player to access a store interface where the player may purchase virtual items.

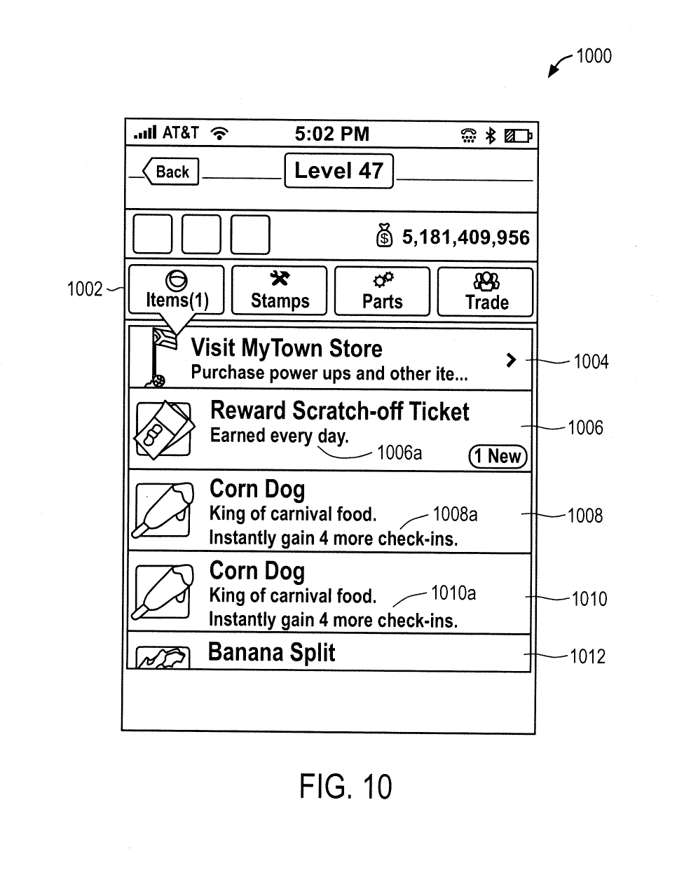

FIG. 10 shows an exemplary virtual item inventory 1000 in some embodiments. In some embodiments, the player may access the virtual item inventory 1000 by activating the item link 920 in the initial screen 900 (see FIG. 9). The virtual item inventory 1000 may also appear when a user checks-in to a local attraction and indicates a desire to use one or more virtual items. A user may interact with the virtual item inventory 1000 using category tabs 1002.

Category tabs 1002 may include an items tab, a stamps tab, a parts tab, and a trade tab. The items tab may display a list of virtual items that may be immediately used or used by a player in conjunction with a check-in. For example, a player may select the reward scratch-off ticket to win virtual currency, points, or virtual items. In another example, a player may select the banana split virtual item during check-in to increase the amount of virtual currency or points received at check-in.

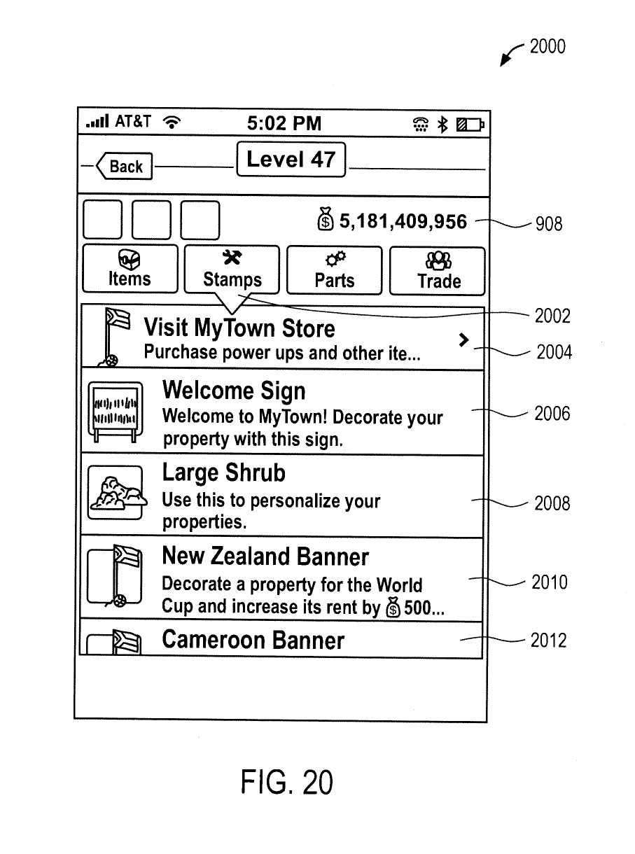

The stamps tab may display a variety of stamps (e.g., pictures of various objects) that may be used to decorate one or more purchased properties in the virtual town. An exemplary stamps tab is discussed in greater detail in the context of FIG. 20 below.

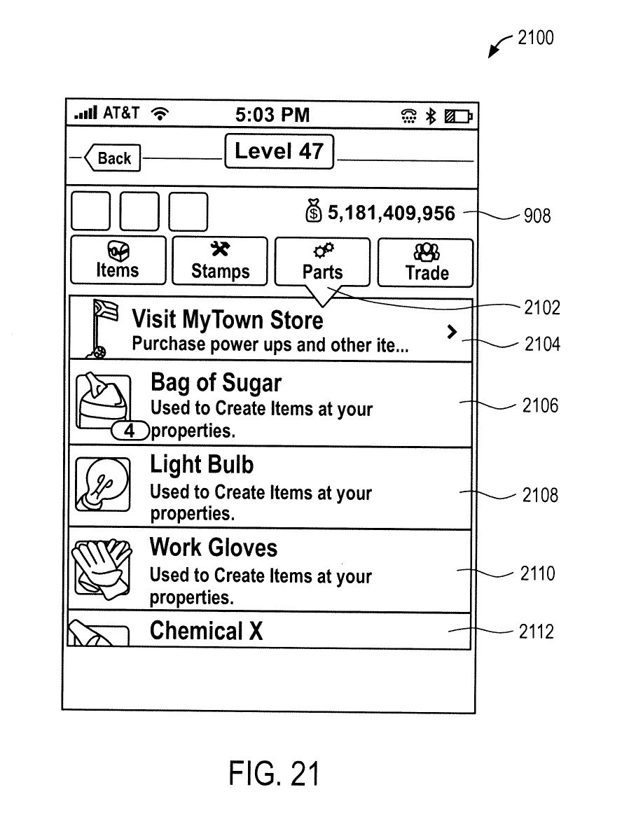

The parts tab may display a variety of virtual items that are parts of other virtual items that may provide enhance gameplay functionality. For example, the parts tab may display components that may be used to build new virtual items that enhance the user's gameplay experiences. An exemplary parts tab is discussed in greater detail in the context of FIG. 21 below.

The trade tab may display a list of other uses and/or virtual items that may be traded. In some embodiments, a user may identify one or more other users of different games and identify them as friends. Associated users may trade or exchange virtual items for mutual benefit. In one example, a user may receive a virtual item that they need to complete a larger virtual item. In some embodiments, some virtual items may be required to be traded by a predetermined number of users. For example, a virtual item may be traded by three different users before providing virtual currency or points to one or more of the different users.

The store link 1004 may connect the user to an online store that allows the user to purchase additional virtual credits or additional virtual items. The online store may further facilitate a competitive advantage to the user during gameplay. For instance, the store link 1004 may allow a user to purchase “power ups” with respect to one or more virtual items or attractions. The “power ups” may provide a competitive advantage in the user's virtual town. In exemplary embodiments, the store link 1004 may also link the user to other online sites having items that the user can purchase. For example, the store link 1004 may allow the user to purchase audio, video, media, or other items.

In some embodiments, the virtual item inventory 1000 includes a first virtual item link 1006. The first virtual item link 1006 may connect the user to a first virtual item. For instance, the first virtual item link 1006 may connect the user to an interactive game such as a reward scratch-off ticket. In exemplary embodiments, the first virtual item link 1006 has an earning interval 1006a.

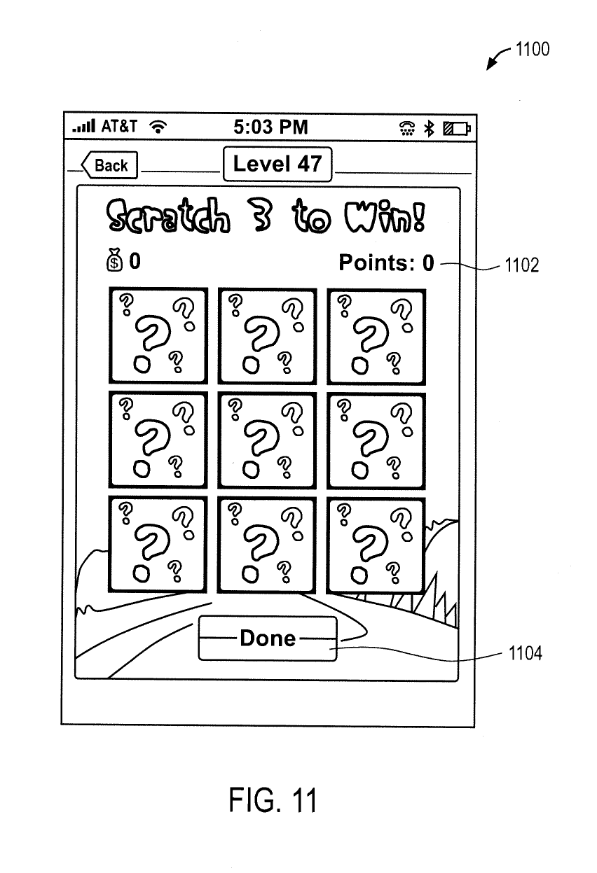

The earning interval 1006a indicates that the virtual item, here a scratch-off ticket, may be earned at predetermined intervals. For example, a virtual item may be earned daily, weekly, monthly, annually, periodically, at another specified interval, or at random. In some embodiments, the user may earn a new reward scratch-off ticket daily. Further details regarding the reward scratch-off ticket are illustrated in connection to FIG. 11, discussed below.

The virtual item inventory 1000 in FIG. 10 also includes a second virtual item link 1008. The second virtual item link 1008 connects the user to a second virtual item. As shown in FIG. 10, the second virtual item link 1008 connects the user to an interactive item such as a virtual corn dog. The interactive item may be a virtual version of an item that the user encounters in the real world. The virtual corn dog, for instance, may have an icon that resembles a fast food snack.

In exemplary embodiments, the second virtual item 1008 has an incentive 1008a. An incentive is a user interface element configured to encourage users to interact with an associated virtual item by providing the users with something in return. As part of gameplay, the incentive 1008a provides four more check-ins when the user uses the virtual item. Once the virtual item, such as the corn dog, is used, the virtual item is removed from the inventory and the user receives the benefit.

The virtual item inventory 1000 may also include a third virtual item link 1010. The third virtual item link 1010 may have an associated incentive 1010a. As shown in FIG. 10, the third virtual item link 1010 may include another virtual corn dog similar to the second virtual item link 1008. The incentive 1010a may also be similar (i.e., provide four check-ins) to the incentive 1008a. It is noted that the user may increase or decrease additional check-ins, virtual currency, or virtual credits as the user interacts with other virtual items during gameplay.

The virtual item inventory 1000 may also include the fourth virtual item link 1012. Like the other virtual item links 1006, 1008, and 1010, the fourth virtual item link 1012 may connect the user to an interactive virtual item, such as a “banana split.” In an example, a user may use the banana split in conjunction with a check-in at a local attraction to further increase virtual currency or points.

In some embodiments, a user may scroll down the inventory to view and/or select other virtual items. As the user interacts with these and other virtual items during gameplay, the user may earn virtual credits, virtual currency, check-ins, and other items.

FIG. 11 shows a scratch game screen 1100 in some embodiments. The scratch game screen 1100 supplies an interactive game during gameplay. The scratch game screen 1100 may display any number of covered boxes or other shapes. The user may uncover or scratch off the boxes or other shapes to win virtual currency or points. The user may also uncover a no-win symbol indicating that the user will not win any virtual currency or points with the scratch game in the scratch game screen 1100.

The scratch game screen 1100 may also include an exit button 1104 to facilitate exiting the scratch game. For instance, the exit button 1104 may redirect the mobile device user to the virtual item inventory 1000, shown in FIG. 10.

For example, the user receiving the scratch game 1100 may scratch off one of the squares. If the square contains virtual currency and/or virtual points, the user may hit the exit button 1104 to take their winnings. Alternately, the user may scratch another square to attempt receive additional virtual currency and/or virtual points. If the user uncovers the no-win symbol, the user may lose all virtual currency and points associated with the particular scratch game screen 1100. In some embodiments, the user is granted one “undo” option that allows a user to undo scratching a no-win symbol. In various embodiments, the user is granted only a limited number of “undo” options (e.g., only one “undo” per scratch game). Further, the game may limit the number of boxes the user may scratch off to three. If the user wins virtual currency and/or points after scratching three squares, the user may be required to exit the scratch game and receive their winnings. Those skilled in the art will appreciate that the user may be limited to any number of squares that may be scratched before the user is required to exit the scratch game. Alternately, the user may have no limit. The scratch game may also provide the winner with virtual items.

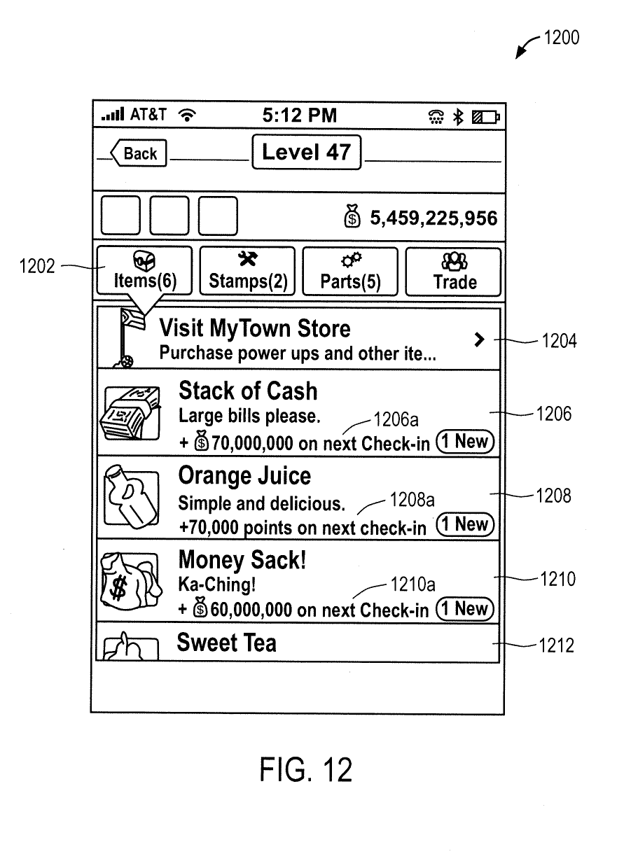

FIG. 12 is another virtual inventor 1200 in some embodiments. As in the first virtual item inventory 1000 (shown in FIG. 10), the second virtual item inventory 1200 in FIG. 12 may include a store link 1204. Further, the second virtual item inventory 1200 may comprise a first virtual item link 1206. The first virtual item link 1206 may connect the user to a first virtual item such as a virtual “Stack of Cash.” In exemplary embodiments, the first virtual item 1206 has an incentive 1206a. Here, when the user utilizes the Stack of Cash in conjunction with a check-in, the user will receive 70 million in virtual currency as identified by the incentive 1206a. The $70,000,000 would add to the user's already copious $5,459,225,956 in the virtual world of gameplay.

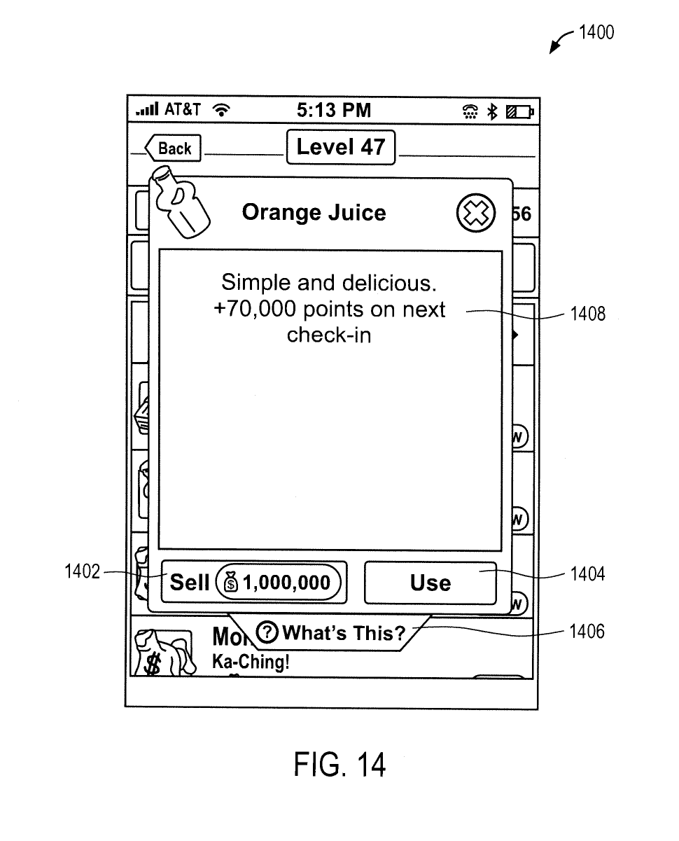

The second virtual item inventory 1200 comprises a second virtual item link 1208. The second virtual item link 1208 may connect the user to a bottle of orange juice. The second virtual item 1208 has an incentive 1208a. As part of gameplay, the incentive 1208a may provide the user with 70,000 virtual points on the next check-in for interacting with the second virtual item 1208. Additional details on how a user interacts with the orange juice virtual item are provided in the context of FIG. 14 below.

Further, the second virtual item inventory 1200 may comprise a third virtual item link 1210. The third virtual item link 1206 may connect the user to third virtual item such as a bag of currency. The third virtual item 1210 may have an incentive 1210a, such as providing $60,000,000 to the user when used in conjunction with a check-in.

Gameplay may also include catchy phrases such as advertising slogans, music, animation, movies, or sounds or the like to induce players to interact with virtual items. For instance, gameplay may associate the first virtual item 1206a may with the phrase “Large bills please.” Gameplay may also associate the second virtual item 1208a with the phrase “Simple and delicious,” in reference to advertising slogans. Gameplay may associate the third virtual item 1210a with the phrase “Ka-Ching,” simulating the sound of many coins falling into a bag.

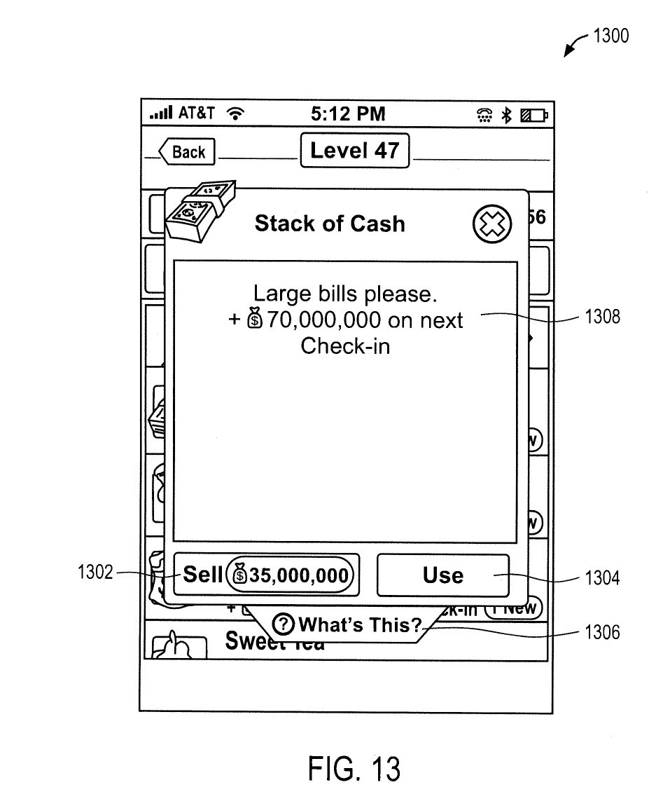

FIG. 13 shows a stack of cash screen 1300 in some embodiments. In some embodiments, the user may receive the stack of cash screen 1300 after the user selects the stack of cash from the virtual item inventory (for instance by clicking on the first virtual item link 1206 shown in FIG. 12). The stack of cash screen 1300 may comprise a sell button 1302, a use button 1304, and a help button 1306. A user may sell a virtual item by activating or clicking the sell button 1302. In this example, the stack of cash virtual item may be sold for 35 million virtual currency. However, if the user uses the virtual item in conjunction with a check-in (i.e., activates the use button 1304), the user may receive 70 million in virtual currency upon check-in. In various embodiments, the sell price and the virtual currency benefit may be the same. A user engaging in competitive gameplay may therefore leverage his or her virtual currency according to his or her interests in the virtual world. Clicking the help button 1306 may direct the user to a help screen where the users may receive additional information about the game and/or virtual items.

FIG. 14 shows an orange juice screen 1400 in some embodiments. In some embodiments, the user may receive the orange juice screen 1400 after the user selects the orange juice from the virtual item inventory (for instance by clicking on the first virtual item link 1208 shown in FIG. 12). Like the stack of cash screen 1300, the orange juice screen 1400 may comprise a sell button 1402, a use button 1404, and a help button 1406. The user may sell the orange juice for 1 million virtual currency or gain 70,000 points if used in a subsequent check-in. Also similar to the stack of cash screen 1300, clicking the help button 1406 may direct the user to a help screen where the users may receive additional information about the game and/or virtual items.

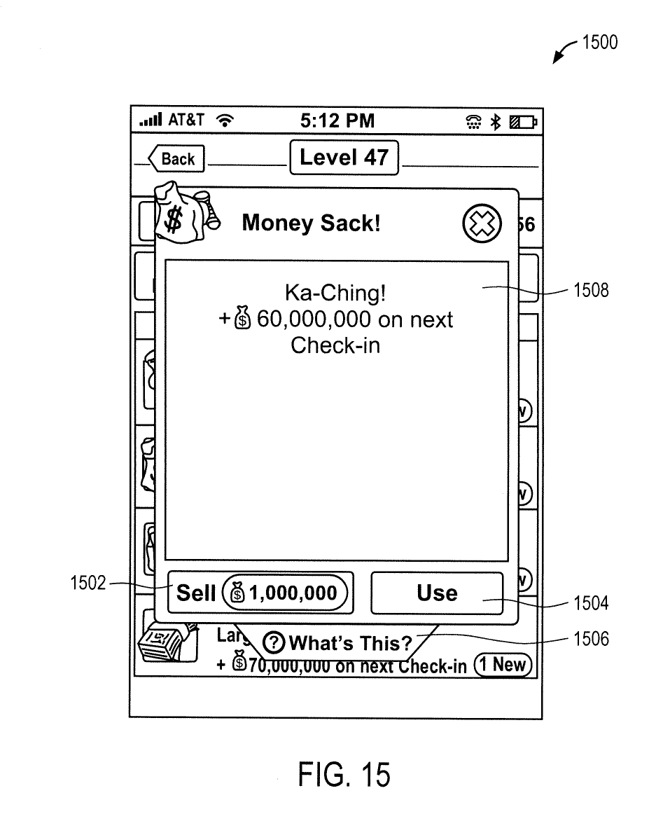

FIG. 15 shows a money sack screen 1500 in some embodiments. In some embodiments, the user may receive the money sack screen 1500 after the user selects the money sack from the virtual item inventory (for instance by clicking on the first virtual item link 1210 shown in FIG. 12). Like the stack of cash screen 1300, the money sack screen 1500 may comprise a sell button 1502, a use button 1504, and a help button 1506. The user may sell the money sack for 1 million virtual currency or gain 60 million virtual currency if used in a subsequent check-in. Also similar to the stack of cash screen 1300, clicking the help button 1506 may direct the user to a help screen where the users may receive additional information about the game and/or virtual items.

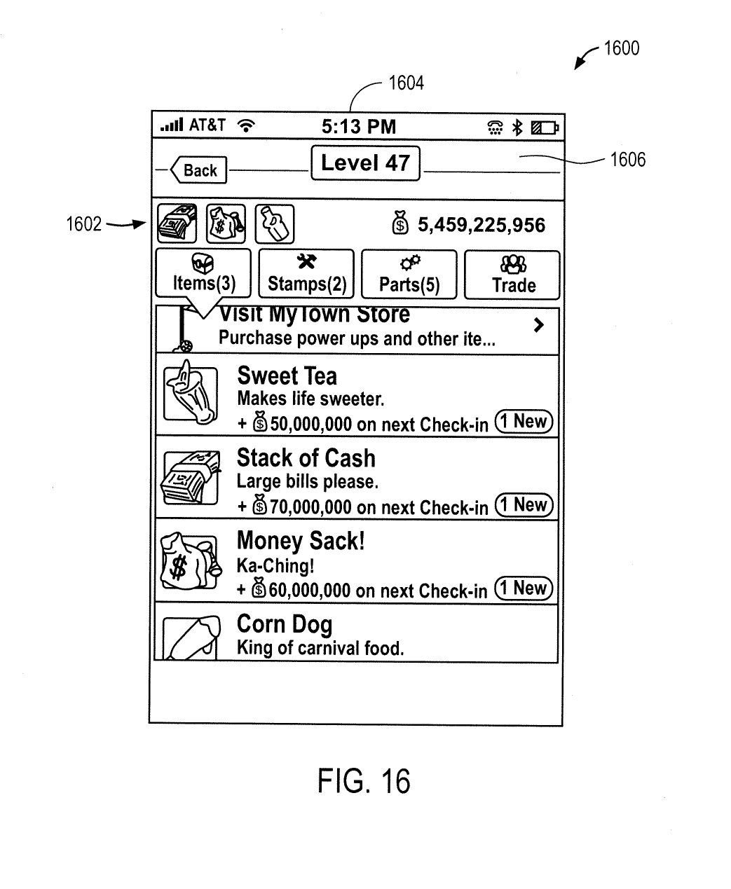

FIG. 16 shows another virtual item inventory 1600 in some embodiments. In various embodiments, a user may use multiple virtual items in conjunction with a single check-in. The user, however, may be limited to a predetermined number of virtual items that may be used at a single instance. For example, a user may use three virtual items in conjunction with a single check-in. In this example, a list of items to be used 1604 appears at the top of the virtual item inventory 1600 which indicates that the user has chosen to use the stack of cash virtual item, the money sack virtual item, and the orange juice virtual item in the next check-in. As a result, the user will receive a bonus of 130 million virtual currency and a bonus of 70,000 points upon the next check-in (i.e., 70 million virtual currency for the stack of cash virtual item, 60 million virtual currency for the money sack virtual item, and 70,000 points for the orange juice virtual item). Accordingly, those items have been removed from the virtual item inventory. The user may access those selections by interacting with the list of items to be used 1602 to undo any of those selections. After the next check-in occurs, the list of items to be used 1602 will appear empty.

FIG. 17 depicts the local attraction screen 1700 in some embodiments. A user may receive the local attraction screen once the user indicates a desire to check-in. The local attraction screen may provide a list of possible attractions that are available for check-in. The list may be populated and sorted based on proximity of a digital device (e.g., smartphone) to the local attractions. The attraction selection screen 1700 comprises a location box 1702 and attraction listings 1704, 1706, 1708, 1710, and 1712. The location box 1702 may comprise a text box where a user may search for specific local attraction. As shown, a user may be near attractions such as Santa Clara County Model Park, having an address of 10250 Monterey Rd., Encinal Elementary School having an address of 9530 Monterey Rd., Charger School of Morgan Hill having an address of 9530 Monterey Rd., Pinoy Lichon Bbq & Grill having an address of 10980 Monterey Rd., and Chimichanga Restaurant having an address of 10980 Monterey Rd. Each of these attractions correspond to real-world attractions that are physically close to the user and have a counterpart in the virtual world of gameplay.

FIG. 18 is a local attraction check-in screen 1800 in some embodiments. The user may receive the local attraction check-in screen 1800 to check-in to the Santa Clara County Model Park by interacting with or clicking on the attraction listing 1704 in FIG. 17. The attraction check-in screen 1800 includes a review box 1802, a Facebook notifier 1804, a Twitter notifier 1806, a business details section 1808, a proximity indicator 1810, and a check-in interface 1812.

The review box 1802 allows the user to post a review of the attraction or indicate a “tip” to other users. The Facebook notifier 1804 and the Twitter notifier 1806 allow the user to notify Facebook, Twitter, or any other program of the check-in at the local attraction. The business details section 1808 may provide real-life information about the physical attraction, such as its location, phone numbers, map, pricing, and “tips” from other users. The business details section 1808 may also provide virtual-world details about the attraction, such as other users who have checked-into the attraction, virtual owners of the attraction, virtual rents associated with the attraction, and virtual items associated with the attraction

The proximity interface 1810 may indicate how close the user and/or the user's digital device is to the proximity interface. (e.g., based on GPS or triangulation of cell towers or other wireless devices). In some embodiments, the user will earn more points upon check-in of a local attraction that is very close to the user. The check-in button 1812 allows the user to check-in to the attraction and get a number of points as indicated on the check-in button.

In some embodiments, checking-into the local attraction further enhances the player's connection between the virtual world of gameplay and the real-world. For example, checking into the local attraction connects the real-life attraction to a version of the local attraction that resides in the virtual world of gameplay. Businesses may encourage specific virtual items, additional virtual currency, and/or virtual points that enhance gameplay in order to drive players to their businesses.

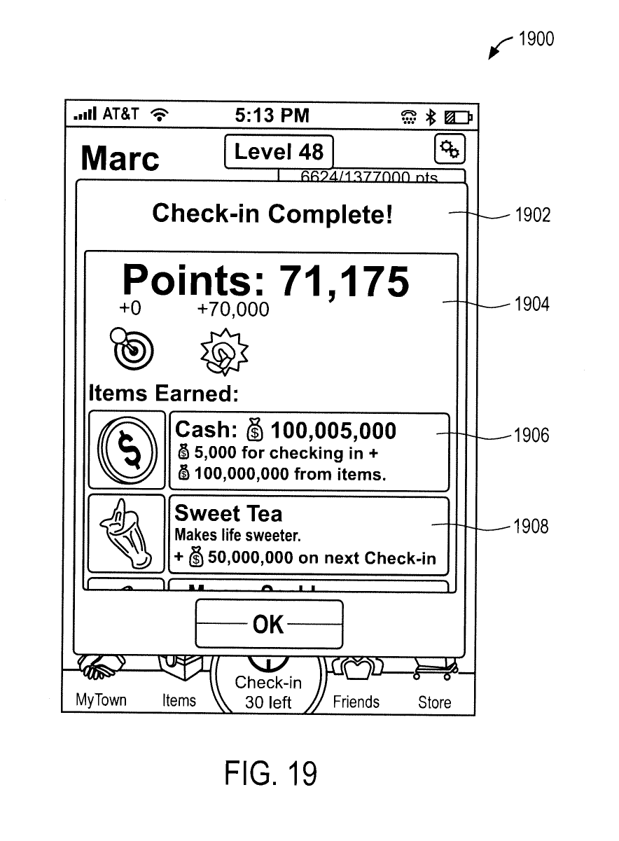

FIG. 19 is the completed check-in screen 1900 in some embodiments. Once a user has checked-into an attraction, the user may be directed to a completed check-in screen. In some embodiments, the completed check-in screen 1900 includes a status box 1902, a point status indicator 1904, and virtual items 1906 and 1908. For example, the player earns 71,175 points for checking into the Santa Clara County Model Park. The user also received 100,005,000 in virtual currency for check-in (as depicted by the virtual item 1906) and a sweet tea virtual item where the player may earn more points and/or virtual currency in the next check-in

FIG. 20 is a stamp screen 2000 in some embodiments. In various embodiments, a user may activate the stamps tab to access a stamp inventory. As discussed previously, stamps may be used to decorate or customize a building or other property in the user's virtual town. Specific stamps in the stamp screen 2000 may change the virtual representation of a specific property and may facilitate upgrades to those properties. For instance, a player may utilize a welcome sign 2006 to decorate a specific property. A player may also place a large shrub 2008 to add foliage to the property thereby increasing the virtual “curb appeal.” A player may also add banners, such as a New Zealand banner 2010 or a Cameroon banner 2012, to their property (e.g., during World Cup play). Stamps may also allow a user to increase the value of the property (e.g., increase the rent of the property by 500 virtual currency when the New Zealand banner is added to a property.

FIG. 21 depicts a parts screen 2100 in some embodiments. The user may access the parts screen 2100 after activating the parts tab. A parts inventory may be depicted in the parts screen 2100. The parts inventory may comprise a bag of sugar 2106, a light bulb 2108, work gloves 2110, and chemical X 2112. The bag of sugar 2106 indicates that the user currently has four bags of sugar in inventory. A user may have any number of parts in the parts inventory.

The parts inventory may comprise virtual items that may be combined with one or more other virtual items to create a new virtual item. Different virtual items which are made by a user may be further combined to create another virtual item. In some embodiments, the new virtual item may be associated with one or more buildings of a virtual town. The new virtual item may increase a user's points, levels, virtual currency, or the like. In some embodiments, the new virtual item may increase the chance of the user to obtain virtual items when the user checks-in.

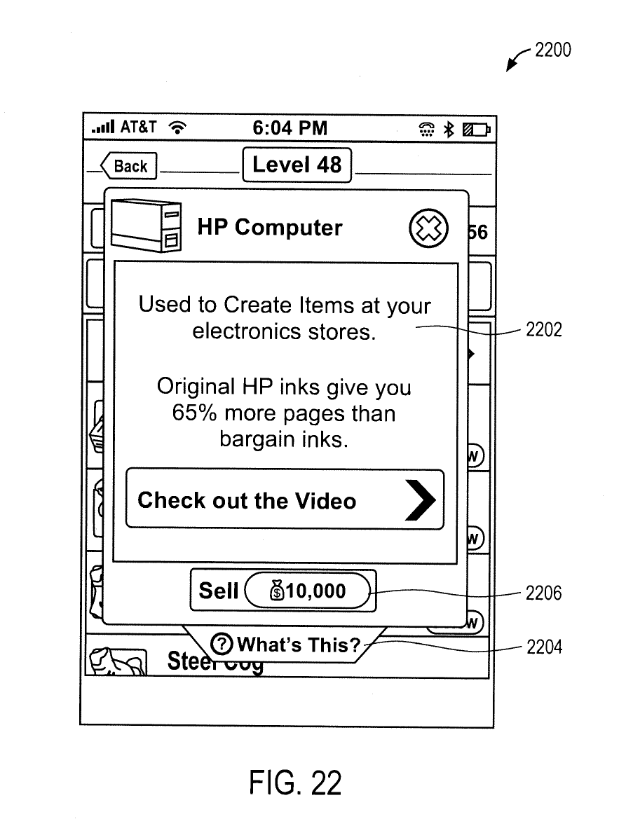

FIG. 22 is an advertisement screen 2200 in some embodiments. As part of revenue generation for gameplay operators, gameplay may provide commercial information integrated into virtual items. For example, a user may receive a representation of an HP computer as a virtual item when the user check's into a local attraction. If the user selects the HP computer in the virtual item inventory, the user may receive the advertisement screen 2200. The advertisement screen 2200 may comprise an interaction dialog box 2202, a sale button 2204, and a user input button 2206. The interaction dialog box 2202 may comprise information on the virtual item, information regarding a coupon or available discount, branding information, or the like.

The sale button 2204 allows a user to sell the virtual item for 10,000 in virtual currency. In some embodiments, the sell price of the virtual item may increase if the user interacts with the advertisement (e.g., watches a video) or shares the virtual item with others.

The user input button 2206 allows a user to continue to interact with the advertisement. For example, by clicking the user input button 2206, a user may view an advertisement or receive additional information regarding HP computers (e.g., their features, where to buy, and the like). The user may receive video, audio, information, chat, email, pictures, html, xml, or any other kind of information or media.

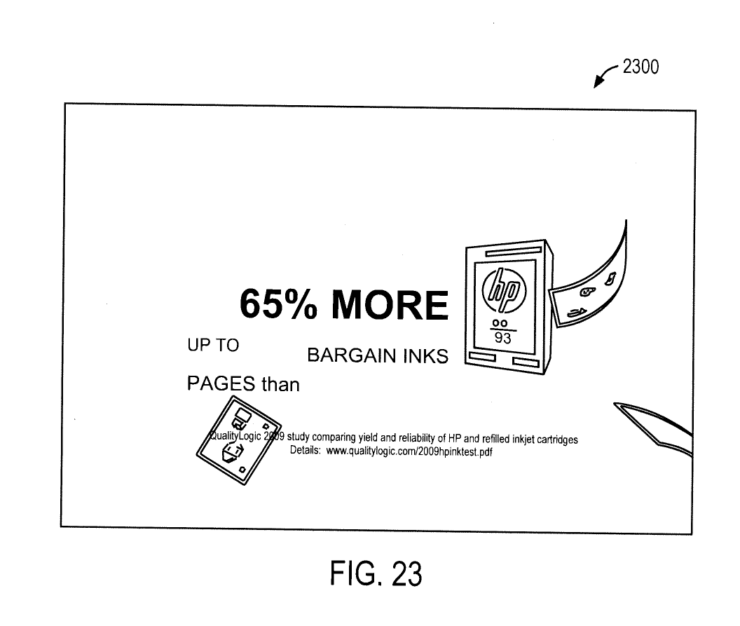

FIG. 23 depicts a video regarding savings associated with HP in some embodiments. In some embodiments, the user may receive the video regarding saving associated with HP when the user activates the user input button 2206 (see FIG. 22) By integrating commercial material into virtual items, gameplay can therefore provide users with a seamless blend of real-world attractions, commercially-relevant material, and a virtual world in which a user can thrive.

The various embodiments set forth herein may be implemented utilizing hardware, software, or any desired combination thereof. When implemented in software, a processor may execute instructions for performing some or all functions described herein. The executable instructions may be stored in a computer readable medium or media. The computer readable medium may include any form of memory such as, but not limited to, RAM, ROM, NAND, NOR, hard disk, flash, CD ROM, DVD, etc. For that matter, any type of logic may be utilized which is capable of implementing the various functions set forth herein. Components may be implemented using a programmed general-purpose digital computer, using application specific integrated circuits, or using a network of interconnected conventional components and circuits. Connections may be wired, wireless, modem, etc. As further used herein, the word “or” is to be interpreted as comprising “and/or,” an exclusive OR function, or any permutations thereof.

The foregoing description is provided to enable any person skilled in the art to make and use the invention and is provided in the context of a particular application. Various modifications to the embodiments are possible, and the generic principles defined herein may be applied to these and other embodiments and applications without departing from the spirit and scope of the invention. Thus, the invention is not intended to be limited to the embodiments and applications shown above, but is to be accorded the widest scope consistent with the principles, features and teachings disclosed herein. The embodiments described herein are not intended to be exhaustive or limiting. The present invention is limited only by the following claims.

While preferred embodiments of the present inventive apparatus and method have been described, it is to be understood that the embodiments described are illustrative only and that the scope of the embodiments of the present inventive apparatus and method is to be defined solely by the appended claims when accorded a full range of equivalence, many variations and modifications naturally occurring to those of skill in the art from a perusal thereof.

1. A system comprising:
a location engine for detecting the location of the system;
an attraction engine for identifying an attraction proximate to the system;
a gameplay engine for enabling gameplay of a user to earn virtual credits based on the proximity; and
a virtual item engine for providing a virtual item to the user during gameplay, the virtual item having a real-world implication and being usable by the gameplay engine for an increase or decrease of virtual credits.

2. The system of claim 1, wherein the virtual item identifies a real-world item.

3. The system of claim 2, wherein the real-world implication is a good, service, person, establishment, or entertainment experience.

4. The system of claim 2, wherein the real-world implication includes audio, video, or text content.

5. The system of claim 2, wherein the real-world implication includes a video game.

6. The system of claim 1, wherein the attraction includes a business, residence or other location.

7. The system of claim 1, wherein the attraction includes an event.

8. The system of claim 7, wherein the event exists only during a specified time period.

9. The system of claim 1, wherein the virtual item includes branding or advertisement information.

10. The system of claim 1, wherein the virtual item includes a coupon.

11. The system of claim 1, wherein the virtual item includes audio, video, or text.

12. The system of claim 1, wherein the virtual item engine selects the virtual item from a data structure of virtual items.

13. The system of claim 12, wherein the virtual item is selected based on user location.

14. The system of claim 12, wherein the virtual item is selected based on likely proximity of the user to a real-world item.

15. The system of claim 12, wherein the virtual item is selected based the attraction.

16. The system of claim 12, wherein the virtual item is selected based on environmental factors.

17. The system of claim 12, wherein the virtual item is selected based on economic factors.

18. The system of claim 12, wherein the virtual item is selected based on information about the user.

19. The system of claim 12, wherein the virtual item is selected based on the time of day.

20. The system of claim 12, wherein the virtual item is selected at random.

21. The system of claim 12, wherein the virtual item is selected based on information about other persons associated with the user.

22. The system of claim 1, wherein the virtual item has real-world implication if combined with other virtual items.

23. The system of claim 1, wherein the virtual item has real-world implication if transmitted to other users.

24. The system of claim 1, wherein the virtual credits include virtual cash, points, levels, tools, or achievements.

25. The system of claim 1, wherein gameplay includes enabling a user to check-in at the attraction in exchange for virtual credits.

26. The system of claim 1, wherein gameplay includes enabling the user to purchase the attraction using virtual credits.

27. The system of claim 1, wherein the gameplay engine enables a user to earn virtual credits based on the proximity by enabling a user to interact with the attraction only when the user is within a predetermined distance of the attraction.

28. The system of claim 1, wherein the virtual item is usable by the gameplay engine for an increase or decrease of virtual credits by affecting the value of another virtual item.

29. The system of claim 1, wherein the virtual item is usable by the gameplay engine for an increase or decrease of virtual credits by affecting a proximity threshold or a proximity award.

30. The system of claim 1, wherein the virtual item is usable by the gameplay engine for an increase or decrease of virtual credits by receiving a tool capable of improving the user's chance of increasing or decreasing virtual credits.

31. A method comprising:
enabling gameplay of a user to earn virtual credits based on proximity of a mobile device to a user-selected attraction;
selecting an interactive virtual item having a real-world implication, the selection based at least in part on an attribute of the user-selected attraction;
sending the interactive virtual item to the mobile device;
receiving interaction information relating to the interactive virtual item; and
modifying the virtual credits based on the interaction information.

32. The method of claim 31, wherein selecting the interactive item comprises evaluating web analytic data corresponding to the user.

33. The method of claim 31, further comprising modifying the virtual item based on the interaction information.

34. A computer readable medium having embodied thereon executable instructions, the executable instructions being executable by a processor for performing a method, the method comprising:
enabling gameplay of a user to earn virtual credits based on proximity of a mobile device to a user-selected attraction;
selecting an interactive virtual item having a real-world implication, the selection based at least in part on an attribute of the user-selected attraction;
sending the interactive virtual item to the mobile device;
receiving interaction information relating to the interactive virtual item; and
modifying the virtual credits based on the interaction information.
